(19) United States
(12) Patent Application Publication
(10) Pub. No.: US 2026/0200610 A1
(43) Pub. Date: Jul. 16, 2026

(54) Vehicle Recovery System

(71) Applicant: The Johns Hopkins University, Baltimore, MD (US)

(72) Inventors: Richard A. Startt, Taneytown, MD (US); Da Xu, Fulton, MD (US); Michael K. Qin, Arlington, VA (US); Nicholas J. Zielinski, Baltimore, MD (US); Garrett M. Krol, Baltimore, MD (US)

(21) Appl. No.: 19/136,781

(22) PCT Filed: Oct. 13, 2023
(86) PCT No.: PCT/US2023/076846

§ 371 Date: Jun. 6, 2025

Related U.S. Application Data
(60) Provisional application No. 63/387,698, filed on Dec. 16, 2022.
(60) Provisional application No. 63/476,455, filed on Dec. 21, 2022.

(51) Int. Cl. B64U 70/00; B64U 10/14; B64U 20/30; B64U 50/37; B64U 60/60; B64U 80/25; B64U 80/30; B64U 80/40; H02J 50/10

(52) U.S. Cl. CPC B64U 70/00; B64U 10/14; B64U 20/30; B64U 50/37; B64U 60/60; B64U 80/25; B64U 80/30; B64U 80/40; H02J 50/10

(57) ABSTRACT

A vehicle recovery system may include a capture assembly and a parking assembly. The capture assembly may include a guide surface and a capture passageway. The guide surface may extend from the capture passageway such that a distal area defined by a perimeter of a distal edge of the guide surface is larger than a proximal area defined by a perimeter of a proximal edge of the guide surface adjacent to the capture passageway. The guide surface may be angled to funnel an unmanned vehicle towards the capture passageway in response to the unmanned vehicle impacting the guide surface. The parking assembly may include a containment device defining a vehicle receiving space. The containment device may be positioned such that the unmanned vehicle moves into the vehicle receiving space without requiring use of a propulsion system of the unmanned vehicle after passing through the capture passageway.

### CROSS REFERENCE TO RELATED APPLICATIONS

This application is a U.S. national stage under 35 U.S.C. § 371 of International Application No. PCT/US 2023/076846, filed Oct. 13, 2023, entitled “Vehicle Recovery System,” which claims the benefit of U.S. Provisional Application Nos. 63/387,698, filed on Dec. 16, 2022, and 63/476,455, filed Dec. 21, 2022, the contents of each are incorporated by reference herein in their entirety.

### STATEMENT OF GOVERNMENTAL INTEREST

This invention was made with Government support under contract number N00024-13-D-6400 awarded by Naval Sea Systems Command. The Government has certain rights in the invention.

### TECHNICAL FIELD

Example embodiments generally relate to unmanned vehicle technology, and more specifically relate to technology for recovering unmanned vehicles.

### BACKGROUND

Aerial drones and other unmanned aerial vehicles (UAVs) have proven to be very useful and effective at a wide variety of tasks. UAVs are excellent platforms for aerial survey and reconnaissance applications where the environment in which the UAV will operate may be unknown. When such tasks are complete, the UAVs typically return to a launch site or another recovery site. At the recovery site, the UAV may upload sensor data and recharge.

Automating the process of recovering a UAV and connecting the UAV to a data connection or power source has proven to be a challenge. While some attempts have been made to implement sophisticated trajectory planning and control algorithms to land a UAV at a precise location to make an electrical connection, the complexity and processing needed to perform such an operation can be costly and error prone in non-ideal conditions. This is the case when attempting to land at a stationary location, and the complexity only increases when attempting to land on moving platforms such as surface vessels or other ground vehicles. Due to these issues, manual recovery of UAVs is typically used, where a human operator lands the UAV and brings the UAV to a charging and data station for manual connection to associated cables.

Since swarm implementations of UAVs are becoming more common, manual handling and connecting of cables to landed UAVs is simply not viable due to the high quantity of UAVs that may be operating at the same time. Also, in some military applications, it may be dangerous to position individuals at a recharge location that is within range of the UAV. This is often due to UAVs being non-fixed wing quad-copters that have limited flight time, and therefore frequently need to be recharged. As such, there is a need for improved UAV recovery systems that can operate to efficiently and autonomously recover multiple UAVs and position the UAVs for charging without the intervention of a human operator.

### BRIEF SUMMARY OF SOME EXAMPLES

According to some example embodiments, a vehicle recovery system is provided. The vehicle recovery system may comprise a capture assembly and a parking assembly. The capture assembly may comprise a guide surface and a capture passageway. The guide surface may extend from the capture passageway such that a distal area defined by a perimeter of a distal edge of the guide surface is larger than a proximal area defined by a perimeter of a proximal edge of the guide surface adjacent to the capture passageway. The guide surface may be angled to funnel an unmanned vehicle towards the capture passageway in response to the unmanned vehicle impacting the guide surface. The parking assembly may comprise a containment device defining a vehicle receiving space. The containment device may be positioned such that the unmanned vehicle moves into the vehicle receiving space without requiring use of a propulsion system of the unmanned vehicle after passing through the capture passageway.

According to some example embodiments, a system for unmanned aerial vehicle (UAV) fleet management is provided. The system may comprise a plurality of UAVs, and a vehicle recovery system. The vehicle recovery system may comprise a capture assembly comprising a guide surface and a capture passageway. The guide surface may extend from the capture passageway such that a distal area defined by a perimeter of a distal edge of the guide surface is larger than a proximal area defined by a perimeter of a proximal edge of the guide surface adjacent to the capture passageway. The guide surface may be angled to funnel a UAV towards the capture passageway in response to the UAV impacting the guide surface. The vehicle recovery system may also comprise a parking assembly comprising a plurality of containment devices. Each containment device may define a vehicle receiving space. Each containment device may be positioned such that the UAV captured by the capture assembly is moved into a vehicle receiving space of a containment device without requiring use of a propulsion system of the UAV after passing through the capture passageway.

According to some example embodiments, a method for performing maintenance on an unmanned aerial vehicle (UAV) is provided. The method may comprise receiving an impact of the UAV on a guide surface of a capture assembly, and funneling the UAV, via the guide surface, to and through a capture passageway. The example method may further comprise determining, by control circuitry via a vehicle presence sensor of a containment device, that a vehicle receiving space of the containment device is unoccupied, and moving, by the control circuitry via a distribution actuator, a movable distribution guide surface into alignment with the containment device, in response to determining that the containment device is unoccupied. The example method may further comprise depositing the UAV into the vehicle receiving space of the containment device, without requiring use of a propulsion system of the UAV after passing through the capture passageway; and connecting, by the control circuitry, a charge output connector at an end of a movable charge probe into a physical electrical connection with a charge input connector of the UAV, in response to detecting a presence of the UAV within the vehicle receiving space of the containment device. The example method may further comprise disconnecting, by the control circuitry, the charge output connector at the end of the movable charge probe from the charge input connector of the UAV, in response to determining that charging of the UAV is complete, and moving, by the control circuity, the movable charge probe to retract away from UAV to permit the UAV to launch into airborne flight.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates an unmanned aerial vehicle (UAV) according to some example embodiments;

FIG. 2 illustrates a UAV having an external cage and a gimbal according to some example embodiments;

FIGS. 3A and 3B illustrate a conceptual block diagram of a vehicle recovery system according to some example embodiments;

FIG. 4 illustrates a control system comprising control circuitry for a vehicle recovery system according to some example embodiments;

FIG. 5 illustrates a first example embodiment of a vehicle recovery system according to some example embodiments;

FIG. 6 illustrates a second example embodiment of a vehicle recovery system according to some example embodiments;

FIG. 7 illustrates a third example embodiment of a vehicle recovery system according to some example embodiments;

FIG. 8 illustrates a fourth example embodiment of a vehicle recovery system according to some example embodiments;

FIGS. 9A and 9B illustrates a fifth example embodiment of a vehicle recovery system with a distribution assembly according to some example embodiments;

FIG. 10 illustrates a sixth example embodiment of a vehicle recovery system with a distribution assembly according to some example embodiments;

FIGS. 11A and 11B illustrate a seventh example embodiment of a vehicle recovery system with a distribution assembly according to some example embodiments;

FIG. 12 illustrates an eighth example embodiment of a vehicle recovery system with a distribution assembly according to some example embodiments;

FIG. 13 illustrates a ninth example embodiment of a vehicle recovery system with a queue assembly according to some example embodiments;

FIG. 14 illustrates a tenth example embodiment of a vehicle recovery system for a non-caged and non-gimbaled plurality of UAVs according to some example embodiments;

FIGS. 15A and 15B illustrate a containment device with more specific features for implementing a charging process according to some example embodiments;

FIGS. 16A and 16B illustrate a plug and receptacle for charging a UAV according to some example embodiments;

FIGS. 17A and 17B illustrate magnetic connectors for charging a UAV according to some example embodiments; and

FIG. 18 illustrates a block diagram of a method for recovering a UAV according to some example embodiments.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. As provided herein, the term “or” is intended to have the meaning of the logical “or” operator (in contrast to the exclusive “or” operator) such that A or B means that A is an option, B is an option, and A and B together are an option.

Various example embodiments of a vehicle recovery system, along with associated methods and apparatuses are described herein. According to some example embodiments, a vehicle recovery system may have various structural components that are configured to capture a moving vehicle, such as an unmanned aerial vehicle (UAV), and deposit the vehicle into a containment device of the vehicle recovery system for storage or maintenance. According to some example embodiments, maintenance that may be performed while the UAV is positioned within the containment device may include battery charging. At least a portion of the vehicle's movement through vehicle recovery system to the containment device, according to some example embodiments, may occur without use of the vehicle's propulsion system. Additionally, according to some example embodiments, when charging is complete, the containment device may be configured to permit the vehicle to exit the containment device by, for example, launching into aerial flight from the containment device.

In example embodiments where the vehicle is a UAV, the vehicle recovery system may include a capture assembly that is configured to assist with transitioning the UAV from airborne flight to a parked status in a containment device of the vehicle recovery system. In this regard, the capture assembly may include a guide surface, which may operate as a larger target for the in-flight UAV and the guide surface may direct movement of the UAV after the UAV comes into contact with the guide surface. Interaction with the capture assembly and the guide surface need not require sophisticated spot-landing techniques that require substantial processing of sensor inputs and position information to accomplish. Rather, due to the structural and mechanical aspects of the guide surface, less sophisticated navigation and sensor analysis is required to recover the UAV for maintenance and the like. In this regard, as the UAV comes into contact with the guide surface, angling of the guide surface may direct or funnel the UAV towards a capture passageway that leads to a containment device. In some example embodiments, the guide surface may be in the shape of an interior surface of a cone (e.g., a funnel-shape), the interior surface of a pyramid, or the like. As an alternative to such uniform shapes, the guide surface may also be shaped to include extended portions that extend the reach of the guide surface in one or more directions.

The containment device may be a component of a parking assembly of the vehicle recovery system, and the containment device may include an open volume for receiving the UAV, referred to as the vehicle receiving space. The vehicle recovery system may also include control circuitry, and the containment device may include a vehicle presence sensor. The vehicle presence sensor may be configured to detect when a UAV is present within the vehicle receiving space of a containment device. The control circuitry may be configured to receive a signal from the vehicle presence sensor indicating that a UAV is present within the vehicle receiving space of the containment device (i.e., the containment device is occupied), and control a charging apparatus of the containment device to initiate charging of an energy storage device (e.g., battery, fuel cell, or the like) of the UAV. Such charging may be performed via a physical electrical connection or via a wireless charging approach (e.g., inductive charging).

In some example embodiments, the UAV may comprise a propulsion platform, for example with motorized propellers, surrounded by an external cage. Examples of such UAVs may be further described in PCT Patent Application No. PCT/US23/73628, filed on Sep. 7, 2023, titled “ROTATABLE EXTERNAL CAGE FOR VEHICLES,” the contents of which are incorporated by reference herein in its entirety. The external cage may operate to protect the propulsion platform from coming into contact with other objects, which otherwise may disrupt the UAV's ability to remain airborne or may damage the UAV. The external cage may be constructed using a collection of interconnected rods that, for example, generally form the structure of a sphere or another shape. The propulsion platform may be connected to the external cage by a gimbal assembly that permits the external cage and the propulsion platform to rotate relative to each other. According to some example embodiments, the gimbal assembly may permit relative rotational movement between the propulsion platform and the external cage in three-dimensions.

Such a UAV, for example, may be disposed in the vehicle receiving space of a containment device, as described above. Since, in some example embodiments, the external cage does not have electrical connections that support charging of the UAV's energy storage device, a charging apparatus of the containment device may be required to interact with the propulsion platform that is within the external cage. Due to the three-dimensional gimbal rotation ability of the propulsion platform within the external cage, the orientation of the propulsion platform can be known based on the center of gravity of the propulsion platform. Therefore, a physical connection to the propulsion platform can be reliably made due to the known orientation of the propulsion platform within the external cage. As such, according to some example embodiments, the charging apparatus may include a moveable charge probe with a charge output connector disposed at the distal end of the moveable charge probe for making a connection to the propulsion platform. In response to detecting the presence of the UAV in the vehicle receiving space of the containment device, the control circuitry may be configured to control a charging actuator to extend the movable charge probe through one of the openings between the interconnected rods of the external cage and make a physical electrical connection with the propulsion platform and, more specifically, a charge input connector of the propulsion platform to perform charging. The connection between the charge output connector of the charging apparatus and the charge input connector of the UAV may be a plug-to-receptacle connection, a magnetic connection, or the like. When charging of the energy storage device is complete, as detected by the control circuitry, the control circuitry may then control the charging actuator to retract the moveable charge probe, and the UAV may be permitted to launch and return to airborne flight, for example, from the containment device and the vehicle receiving space.

According to some example embodiments, the containment device may be one of a plurality of containment devices of the vehicle recovery system, and the parking assembly may comprise a distribution assembly configured to distribute captured UAVs into unoccupied containment devices. In this regard, each containment device may include a respective vehicle presence sensor that is connected to the control circuitry. As such, based on the signals from the respective vehicle presence sensors and a known mapping of the containment devices, the control circuitry may be configured to determine which containment devices are occupied and which are unoccupied.

Additionally, the distribution assembly may comprise a movable distribution guide surface that is operably coupled to a distribution actuator that is controlled by the control circuitry. Accordingly, the control circuitry may control the distribution actuator to move (e.g., rotate, extend, or the like) the distribution guide surface into alignment with, for example, an unoccupied containment device. A captured UAV may pass through the capture passageway and move along the distribution guide surface (e.g., roll on the external cage) and into the unoccupied containment device that is aligned with the distribution guide surface. According to some example embodiments, the distribution assembly may include a queue space where a queue of UAVs may be temporarily held until alignment positioning of the distribution guide surface is performed and a next UAV may be released into an unoccupied containment device. In this manner, the control circuitry may manage the placement of a plurality of UAVs into respective containment devices to perform, for example, charging and other maintenance without requiring any human handling of the UAVs. Additionally, the UAVs may also return to flight from the containment devices without human handling.

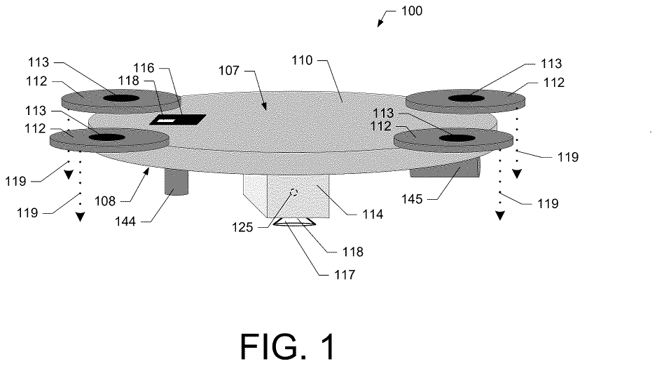

Having described some example embodiments, reference is now made to FIG. 1, which illustrates an example UAV 100, according to some example embodiments. The UAV 100 may include a propulsion platform that may have a plurality of propulsion systems coupled to a body 110. The propulsion systems may comprise a propulsion device, such as a propeller 112. Each propeller 112 may be driven by a controllable motor 113 (e.g., an electric motor) to generate, for example, a thrust 119, which, for explanation purposes, may be directed downward or towards the ground. As such, for flight operation, the UAV 100 may be oriented such that the thrust generated by the propellers 112 is directed downward to lift the UAV 100 from the ground. According to some example embodiments, the UAV 100 may comprise multiple (e.g., four) propellers 112 and respective motors 113, and the UAV 100 may be operated, for example, in a quad-copter configuration. UAV control circuitry 116 may include a processor, memory, and other active and passive components to control operation of the motors 113 to cause the UAV 100 to maneuver in flight. Via independent control of each motor 113, the UAV control circuitry 116 may control the UAV 100 to hover, spin, move in a direction, descend, etc. The processor may be embodied as a microprocessor that executes software or firmware stored in a memory, such as a non-volatile memory. Alternatively, the processor may be hardware configured as, for example, a field programmable gate array (FPGA), an application specific integrated circuit (ASIC), or the like. As a result, the processor of the UAV 100 may be configured to perform controlled movement of the UAV 100 by controlling the operation of the motors 113.

To assist with navigation, particularly in autonomous navigation applications, the UAV control circuitry 116 may include a position sensor 118. The position sensor 118 may be, for example, a global positioning system (GPS) component. The position sensor 118 may be a stand-alone component or the position sensor 118 may be a component of a combined package that includes, for example, an accelerometer, a gyroscope, an altimeter, or the like. Alternatively, the UAV control circuitry 116 may include one or more components comprising an accelerometer, a gyroscope, altimeter, or the like. According to some example embodiments, the position sensor 118, as a GPS component, may be configured to receive signals from orbiting satellites to determine a position of the UAV 100. Accordingly, a signal receiver of the GPS component may be required to be upward or sky-facing in order to receive the satellite signals. For this reason, the GPS receiver may be positioned on a top side 107 of the UAV 100.

Additionally, according to some example embodiments, when considering a gravity environment, the UAV 100 may have a relatively low center of gravity. In this regard, the weight distribution of the UAV 100 may make the UAV 100 “bottom heavy” such that the center of gravity is positioned, for example, below a body 110 or closer to a bottom side 108 of the body 110. According to some example embodiments, a high weight, high density component, such as an energy storage device in the form of an example battery 114, may be affixed to the bottom side 108 of the body 110. As such, the weight distribution caused by this placement of the battery 114 in this way may cause the center of gravity 125 to be positioned, for example, below the body 110, as shown.

According to some example embodiments, the UAV 100 may include a charge connection interface with a charge input connector 118. The charge input connector 118 may be configured to interface with a charge output connector of a vehicle recovery system to perform charging of the battery 114. As further described below, a probe guide 117 may be included that is configured to guide a charge probe, as further described below, into engagement with the charge input connector 118 of the UAV 100. According to some example embodiments, the probe guide 117 may be shaped-similar to a funnel, such that, a charge probe may be redirected by the probe guide 117 into engagement with the charge input connector 118.

Additionally, the UAV 100 may comprise sensors that may be utilized for various applications and tasks. The sensors may provide sensed or detected information to the control circuitry for sharing and analyzing. Such sensors may be optical sensors, optical cameras, thermal cameras or the like. The sensors may also be temperature, humidity, wind speed, and other meteorological sensors. According to some example embodiments, the sensors may be sonar, microphone, or other audio-based sensors. In this regard, according to some example embodiments, the UAV 100 may include one or more cameras, such as, camera 144 and camera 145. According to some example embodiments, camera 144 and camera 145 may be operably coupled to the UAV control circuitry 116, which may be configured to control the operation of the camera 144 and camera 145. The camera 144 may be directed in a downward direction to capture images of the environment below the UAV 100. Camera 145 may be a forward-looking camera that captures images of the environment in front of the UAV 100, for example, during flight. According to some example embodiments, camera 144 or camera 145 may assist with navigation of the UAV 100. In this regard, as further described below, the UAV control circuitry 116 may receive captured images from camera 144 or camera 145 and analyze the captured images to identify a vehicle recovery system. In this regard, a vehicle recovery system may have a capture assembly of a specific color or the capture assembly may include a beacon device that can be identified in the captured images. The UAV control circuitry 116 may cause the UAV 100 to navigate, at least partially, to the vehicle recovery system based on the identifications made in the captured images, or using GPS, or both. According to some example embodiments, the UAV 100 need not have both cameras 144 and 145. In some example embodiments, the UAV 100 may include, for example, camera 145 (e.g., without camera 144) for forward image capture to assist with navigation.

Additionally or alternatively, the UAV 100 may include cargo capabilities. In this regard, the UAV 100 may include a cargo receptacle (not shown) that may, for example, be tethered to the UAV 100. Such a cargo receptacle may be configured to receive a cargo for delivery to a target location. The cargo, according to some example embodiments, may be food supplies, healthcare supplies or equipment, replacement parts, munitions, or the like.

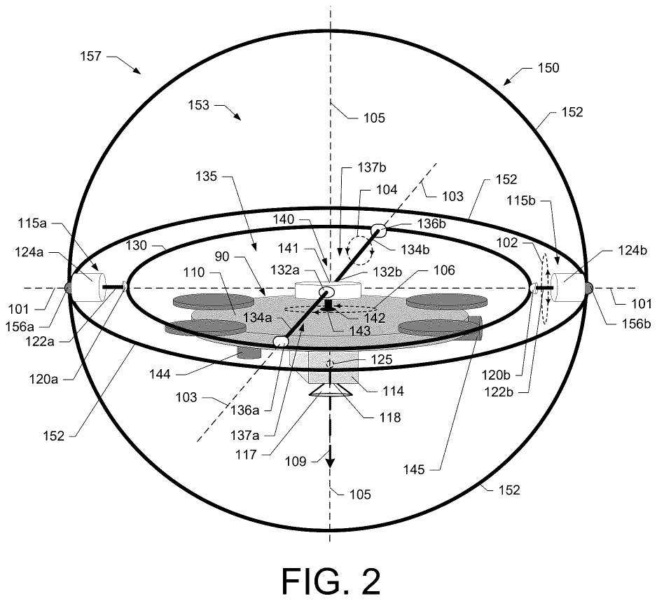

Referring now to FIG. 2, a UAV 157 with an example external cage 150 is shown. The external cage 150 comprises a plurality of rods 152 and a plurality of vertex connectors 156 (individually vertex connector 156a and 156b). In this minimalist example embodiment, the external cage 150 comprises four rods 152 and two vertex connectors 156. Each rod 152 is connected to each vertex connector 156 at its ends, and the rods 152 are bent to form circular shapes. Accordingly, the rods 152 may be formed of an elastic material, such as materials that comprise a plastic (e.g., a polyethylene plastic such as a high or low density polyethylene, nylon, acrylic, polycarbonate, polyvinyl chloride, acrylonitrile butadiene styrene, etc.), or the like, and the rods 152 may be linear when isolated. However, according to some example embodiments, the rods 152 may be formed with a permanent bend, and, for example, elasticity may be introduced by the materials used to make the vertex connectors 156 or the structure of the vertex connectors 156. In this regard, the vertex connectors 156 may be formed of a flexible material, such as a thermoplastic polyurethane (TPU), a rubber, or the like, that enables pivoting of the rods 152 at the connection points with the vertex connector 156.

The UAV 100 may be a component of the UAV 157 as the propulsion platform 90 of the UAV 157. As shown, the propulsion platform 90 has been installed within an internal volume 153 of the external cage 150. Further, the propulsion platform 90 may be operably coupled to the external cage 150 via a gimbal assembly 135, which may be structured as a three-axis gimbal assembly to enable rotation of the external cage 150 relative to the propulsion platform 90 with respect to three axes. The propulsion platform 90 may be operably coupled to the external cage 150 via a gimbal assembly 135 such that the propulsion platform 90 may rotate relative to the external cage 150 about a first axis of rotation 101 as indicated by arrows 102, a second axis of rotation 103 as indicated by arrows 104, and a third axis of rotation 105 as indicated by arrows 106. Each of the first axis of rotation 101, the second axis of rotation 102, and the third axis of rotation 103 may be perpendicular to each other.

In this regard, according to some example embodiments, the gimbal assembly 135 may comprise the gimbal ring 130 that supports rotation about the first axis of rotation 101 and the second axis of rotation 103, and a suspension hub 141 that may embody a component of a rotating assembly 140 that supports rotation of about the third axis of rotation 105. Rotating assembly 115a and rotating assembly 115b may be coupled between the external cage 150 and the gimbal ring 130 to enable relative rotation about the first axis of rotation 101. The rotating assembly 115a may comprise a cage hub 124a, an axle 122a, and an inner hub 120a. In general, one or both of the cage hub 124a and the inner hub 120a may enable relative rotation of the axle 122a to thereby enable relative rotation of the external cage 150 with respect to the propulsion platform 90 about an axis of rotation 101. The axle 122a may be a rotating component that may be configured to rotate with the propulsion platform 90, rotate with the external cage 150, or rotate relative to both the propulsion platform 90 and the external cage 150. Similarly, the rotating assembly 115b may comprise a cage hub 124b, an axle 122b, and an inner hub 120b. In general, one or both of the cage hub 124b and the inner hub 120b may enable relative rotation of the axle 122b to thereby enable relative rotation of the external cage 150 with respect to the propulsion platform 90 about an axis of rotation 101. The axle 122b may be a rotating component that may be configured to rotate with the propulsion platform 90, rotate with the external cage 150, or rotate relative to both the propulsion platform 90 and the external cage 150.

Rotating assembly 137a and rotating assembly 137b may be coupled between the gimbal ring 130 and the suspension hub 141 to enable relative rotation about the second axis of rotation 103. The rotating assembly 137a may comprise a ring hub 136a, an axle 134a, and an inner hub 132a. In general, one or both of the ring hub 136a and the inner hub 132a may enable relative rotation of the axle 134a to thereby enable relative rotation of the gimbal ring 130 with respect to the propulsion platform 90 about the second axis of rotation 103. Similarly, the rotating assembly 137b may comprise a ring hub 136b, an axle 134b, and an inner hub 132b. In general, one or both of the ring hub 136b and the inner hub 132b may enable relative rotation of the axle 134b to thereby enable relative rotation of the gimbal ring 130 with respect to the aeronautic platform 100 about the second axis of rotation 103.

To support three-axis rotation, the suspension hub 141 may be coupled to the gimbal ring 130. Rotating assembly 137a may be coupled to the suspension hub 141 to support rotation of the suspension hub 141 and the propulsion platform 90 about the second axis of rotation 103. The inner hub 132a may be connected to the suspension hub 141 and the axle 134a may be operably coupled to the suspension hub 141. Similarly, rotating assembly 137b may be coupled in the same manner, i.e., between the gimbal ring 130 and the suspension hub 141 to also support rotation of the suspension hub 141 and the propulsion platform 90 about the second axis of rotation 103 and the axle 134b may also be operably coupled to the suspension hub 141. Rotating assembly 137b may be positioned opposite rotating assembly 137a such that both rotating assemblies support rotation of the suspension hub 141 and propulsion platform 90 about the second axis of rotation 103 as indicated by the arrows 104. Accordingly, the inner hub 132b may be connected to the suspension hub 141.

To support relative rotation about the third axis of rotation 105, the gimbal assembly 135 may further comprise rotating assembly 140, which is coupled between rotating assemblies 137a and 137b and the propulsion platform 90. In this regard, the third axis of rotation 105 may be perpendicular to the first axis of rotation 101 and the second axis of rotation 103, and the rotating assembly 140 may be coupled between rotating assemblies 137a and 137b and the propulsion platform 90. According to some example embodiments, the third axis of rotation 105 may be aligned with the center of gravity 125 of the propulsion platform 90 and the intersection of the first and second axes of rotation. Further, according to some example embodiments, the propulsion platform 90 may be wholly or partially suspended from the rotating assembly 140. In this regard, according to some example embodiments, the rotating assembly 140 may comprise a suspension hub 141, an axle 142, and a platform hub 143. In general, one or both of the suspension hub 141 or the platform hub 143 may enable relative rotation of the axle 142 to thereby enable relative rotation of the suspension hub 141 with respect to the propulsion platform 90 about the third axis of rotation 105. The axle 142 may be a rotating component that may be configured to rotate with the propulsion platform 90, rotate with the suspension hub 141, or rotate relative to both the propulsion platform 90 and the suspension hub 141. In this regard, the axle 142 may be rotationally fixed to one of the propulsion platform 90 or the suspension hub 141, or the axle 142 may be rotationally fixed to neither the propulsion platform 90 nor the suspension hub 141. As an example embodiment, the following describes the axle 142 as being rotationally fixed to the platform hub 143 and the propulsion platform 90. However, it is understood that some example embodiments may involve the axle 142 being rotationally fixed to the suspension hub 141 and rotatable within the platform hub 143, or the axle 142 may freely rotate relative to both the suspension hub 141 and the platform hub 143.

In this regard, the suspension hub 141 may be operably coupled to or affixed to the inner hubs 132a and 132b. However, according to some example embodiments, the suspension hub 141 may be positioned at a central location relative to a line from the ring hub 136a and the ring hub 136b. Further, according to some example embodiments, the suspension hub 141 may be positioned at a centroid of the external cage 150. The suspension hub 141 may be affixed to the rotating assemblies 137a and 137b such that the suspension hub 141 does not rotate relative to the rotating assemblies 137a and 137b. The suspension hub 141 may be a component that enables the rotation of a shaft, such as the axle 142 within the suspension hub 141. In this regard, the suspension hub 141 may comprise an opening that the axle 142 may be received into, and the axle 142 may be rotatable within the opening, while also being secured within the suspension hub 141. According to some example embodiments, the suspension hub 141 may comprise additional rotating components, such as a bearing (e.g., a ball bearing) that reduce frictional forces during rotation to enable the axle 142 to rotate more freely. The axle 142 may be rotationally fixed to the platform hub 143. The platform hub 143 may, in turn, be rotationally fixed to the body 110 of the propulsion platform 90. As such, the axle 142, the platform hub 143, and the propulsion platform 90 may, according to some example embodiments, be rotatable as a unit relative to the suspension hub 141 about the third axis of rotation 105.

Due to the operable coupling of the suspension hub 141 between the gimbal ring 130 and the external cage 150, the gimbal ring 130 and the propulsion platform 90 may be free to rotate about the first axis of rotation 101 relative to the external cage 150, according to some example embodiments. Further, due to the coupling of the third rotating assembly 137a and the fourth rotating assembly 137b between the gimbal ring 130 and the propulsion platform 90, the propulsion platform 90 may be free to rotate about the second axis of rotation 103 relative to the external cage 150, according to some example embodiments.

Due to the coupling of rotating assembly 115a and rotating assembly 115b between the gimbal ring 130 and the external cage 150, the coupling of rotating assembly 137a and rotating assembly 137b between the gimbal ring 130 and the propulsion platform 90, and the coupling of rotating assembly 140 as described above, the propulsion platform 90 may be free to rotate about the first axis of rotation 101, second axis of rotation 103, and the third axis of rotation 105. According to some example embodiments, the first axis of rotation 101 may be positioned such that the first axis of rotation 101 is within a first plane that includes the center of gravity 125 and bisects the weight of the propulsion platform 90. The first axis of rotation 101 may also positioned on a second plane that is normal to the weight force vector 109 directed from the center of gravity 125, where a portion of the propulsion platform 90 on a side of the second plane that is intended to be directed towards the ground is heavier than a portion of the propulsion platform 90 that is intended to be directed towards the sky. In the example embodiments described with respect to FIG. 2, the entire weight of the propulsion platform 90 may be on one side of this second plane, when the propulsion platform 90 is not subjected to a moment of force or torque that causes the propulsion platform 90 to pivot relative to the weight force vector 109. Additionally, the second axis of rotation 103 may be positioned such that the second axis of rotation 103 is within a third plane that includes the center of gravity 125, is perpendicular to the first plane, and also bisects the weight of the propulsion platform 90. The second axis of rotation 103 may also positioned on the second plane that is normal to the weight force vector 109 directed from the center of gravity 125, where a portion of the propulsion platform 90 on a side of the of the second plane that is intended to be directed towards the ground is heavier than a portion of the propulsion platform 90 that is intended to be directed towards the sky. Also, the third axis of rotation 105 may be positioned at the intersection of the first plane and the third plane, which defines a line through the center of gravity 125. As such, the free rotation of the propulsion platform 90 about the first axis of rotation 101, the second axis of rotation 103, and the third axis of rotation 105 may result in the top side 107 of the propulsion platform 90 being directed away from the ground and towards the sky. Positioning of the first axis of rotation 101, the second axis of rotation 103, and the third axis of rotation 105 in this manner may cause the propulsion platform 90 to be generally maintained in a desired orientation. As a result, a global positioning receiver (GPS) receiver on the top side 107 may maintain orientation towards the sky to permit satellite signals for GPS positioning to be received. Further, the propulsion platform 90 may rotate, due to gravity, into an orientation that facilitates, for example, charging, as further described below and returning to flight when the aerial vehicle 157 is, for example, at rest, regardless of the position of the external cage 150. In this regard, the propulsion platform 90 may rotate such that the thrust generated by the propellers 112 is directed downward to facilitate flight.

In view of the foregoing, the combination of the external cage 150 and the gimbal assembly 135 constructs a barrier assembly for the propulsion platform 90 and maintains orientation of the propulsion platform 90 relative to the ground. Such a barrier assembly, according to some example embodiments, may provide the propulsion platform 90 with collision protection and orientation benefits that overcome a variety of technical challenges. In this regard, collision impact forces may be reduced by the presence of the rotatable external cage. Additionally, the external cage 150 and gimbal assembly 135 may operate to cause the propulsion platform 90 to maintain a desired orientation relative to the ground, even when flight propulsion is discontinued.

According to some example embodiments, the external cage 150 may be generally spherical in shape, which may permit the UAV 157 to roll. The UAV 157 may roll, for example, on the ground using the flight propulsion capabilities of the UAV 157. Additionally, the UAV 157 may roll without propulsion due to gravity, which may permit the UAV 157 to move within a vehicle recovery system even without propulsion. However, a generally spherical shape is merely an example shape that may be implemented in accordance with some example embodiments. Other shapes may include elongated spheres, cubes, prisms, cones, cylinders, other three-dimensional shapes formed of various shaped polygons, and the like, some of which may roll or slide without propulsion within a vehicle recovery system.

In some example embodiments, the external cage 150 may comprise an interconnection of two-dimensional, polygon shapes sized to form a three-dimensional structure with an internal volume. The polygon shapes may define openings into the internal volume 153 of the external cage 150. According to some example embodiments, a largest dimension of such openings may be smaller than a smallest dimension of the propulsion platform 90. According to some example embodiments, the polygon shapes may make up, for example, the external cage 150 to form an enclosure that defines the internal volume 153, within which the propulsion platform 90 and the gimbal assembly 135 may be disposed.

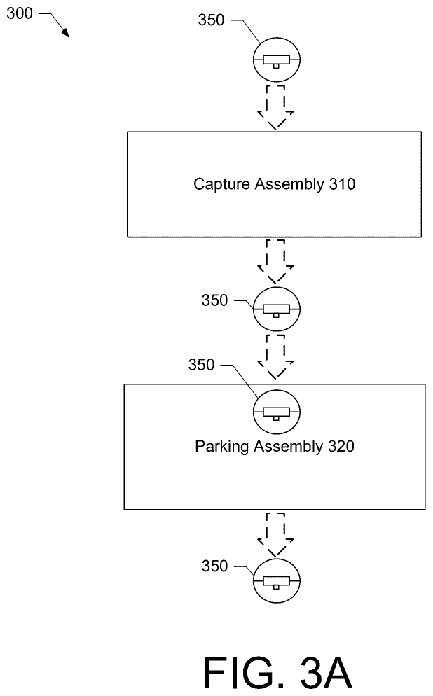

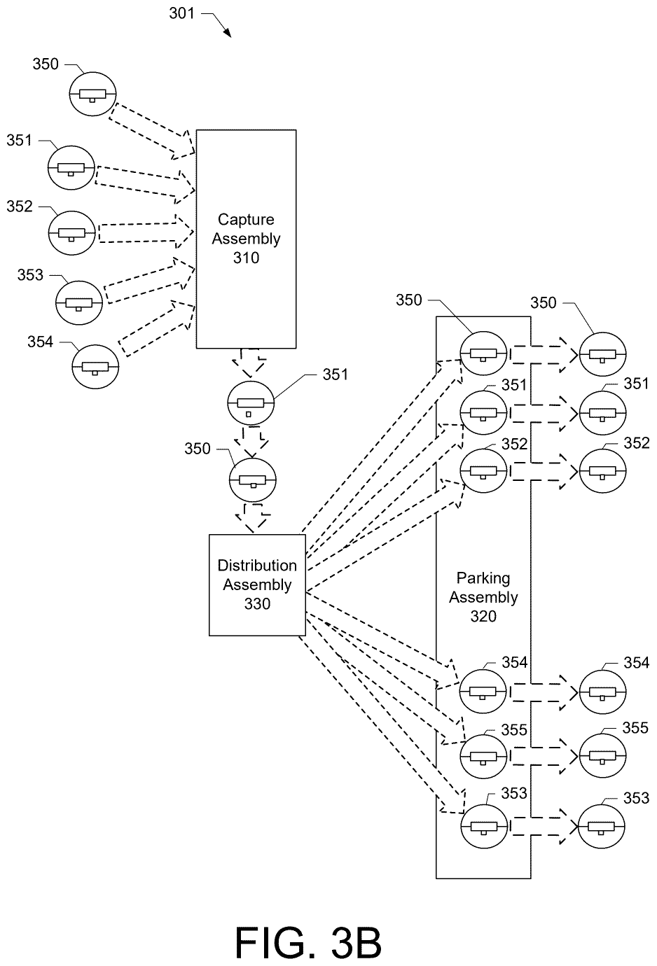

Having described some example embodiments of a vehicle (e.g., UAV 100 and UAV 157) that may operate with a vehicle recovery system as described herein, conceptual block diagrams of some example vehicle recovery systems are shown in FIGS. 3A and 3B. Referring to FIG. 3A, according to some example embodiments, a vehicle recovery system 300 may comprise a capture assembly 310 and a parking assembly 320. As mentioned above, the capture assembly 310 may be configured to receive and direct a vehicle to the parking assembly 320. The parking assembly 320 may be a containment platform the permits the captured vehicle to be stationary or parked for, for example, storage or maintenance.

As shown in FIG. 3A, a UAV 350 moves through the vehicle recovery system 300. The UAV 350 may be an example embodiment of UAV 100, UAV 157, or the like. It is noted that, while UAV 350 visually appears to be similar to UAV 157, example embodiments described herein are also applicable to form factors similar to the UAV 100 or the like. With respect to the movement of UAV 350 as indicated by the arrows, UAV 350 may initially be in flight and navigate to the capture assembly 310. Upon interaction with the capture assembly 310, the UAV 350 may be subjected to controlled movement within the vehicle recovery system 300, in some cases, without requiring use of UAV 350's propulsion system. UAV 350 may move from the capture assembly 310 to the parking assembly 320, where the UAV 350 may be stationary or parked for storage or maintenance. When appropriate (e.g., maintenance is complete, a new mission has been communicated, a predetermined time threshold has been reached), the UAV 350 may use its propulsion system to return to flight from the parking assembly 320. As such, FIG. 3A generally describes the process and structure of the UAV 350 being captured by the capture assembly 310 moved into position within the parking assembly 320 for storage or maintenance, and then permitted to return to flight from the parking assembly 320.

While FIG. 3A illustrates some example embodiment concepts involving a single UAV 350, FIG. 3B illustrates some example embodiment concepts that involve a plurality of UAVs or a fleet of UAVs. As such, the vehicle recovery system 301 supports the capture and selective placement of the captured UAVs within the parking assembly 320. To do so, a distribution assembly 330 may be disposed between the capture assembly 310 and the parking assembly 320.

In this regard, a number of UAVs, i.e., UAV 350, UAV 351, UAV 352, UAV 353, UAV 354, and UAV 355, may be captured by the capture assembly 310, and these captured UAVs may be passed to the distribution assembly 330. The distribution assembly 330, in turn, may distribute the captured UAVs to select locations within the parking assembly 320. As mentioned above, the parking assembly may include a number of containment devices that receive a UAV for storage or maintenance while parked. In an operating vehicle recovery system 301, control circuitry of the vehicle recovery system 301 may determine from vehicle presence sensors, which of the containment devices of the parking assembly are unoccupied. As a result, the distribution assembly 330, according to some example embodiments, may operate to place each UAV in a selected, unoccupied, containment device or parking spot within the parking assembly 320. Once parked, the UAVs may remain stationary within the parking assembly 320 until each UAV is redeployed and returns to flight from the parking assembly 320.

The conceptual flowcharts of FIGS. 3A and 3B provide insight into the approach and operation of some example embodiments of vehicle recovery systems. The following describes a number of example vehicle recovery systems that employ some or all of these concepts. To control the operation of such vehicle recovery systems, the systems may employ control circuitry that receives input from sensors and communications and acts upon or assists the UAVs to be recharged or the like.

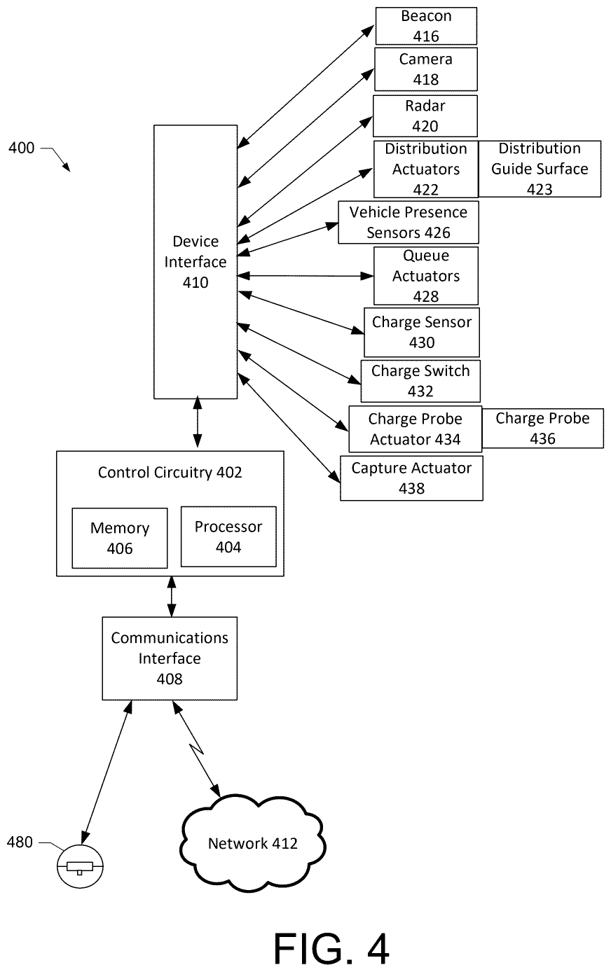

FIG. 4 illustrates a block diagram of control system 400 for vehicle recovery system that comprises control circuitry 402. Control circuitry 402 may, in turn, comprise a processor 404, a memory 406, a communications interface 408, a device interface 410, and a number of input/output devices that may operate to provide information to the control circuitry 402 as an input or operate under the control of the control circuitry 402 as an output. Additionally, the control system 400 may include additional components not shown in FIG. 4 and the control circuitry 402 may be operably coupled to other components not shown in FIG. 4.

Through configuration and operation of the memory 406, the processor 404, the communications interface 408 and the device interface 410, the control circuitry 402 may be configurable to perform various operations and functionalities as described herein. In this regard, the control circuitry 402 may be configured to perform computational processing, motor and actuator control, information retrieval from sensors, or the like, according to an example embodiment. In some embodiments, the control circuitry 402 may be embodied as a chip or chip set. In other words, the control circuitry 402 may comprise one or more physical packages (e.g., chips) including materials, components or wires on a structural assembly (e.g., a baseboard). The control circuitry 402 may be configured to receive inputs (e.g., via peripheral components), perform actions based on the inputs, and generate outputs (e.g., for provision to peripheral components). In an example embodiment, the control circuitry 402 may include a number of instances of a processor 404, associated circuitry, and memory 406. The control circuitry 402 may be embodied as a circuit chip (e.g., an integrated circuit chip, such as a field programmable gate array (FPGA)) configured (e.g., with hardware, software or a combination of hardware and software) to perform operations described herein.

The memory 406 may include one or more non-transitory memory devices such as, for example, volatile or non-volatile memory that may be either fixed or removable. The memory 406 may be configured to store information, data, applications, instructions or the like for enabling, for example, the functionalities of a vehicle recovery system described herein. The memory 406 may operate to buffer instructions and data during operation of the control circuitry 402 to support higher-level functionalities, and may also be configured to store instructions for execution by the control circuitry 402. The memory 406 may also store various information including functional instructions, sensor data, and the like. According to some example embodiments, various data stored in the memory 406 may be generated based on other data and stored or the data may be retrieved via the communications interface 408 and stored in the memory 406.

The communications interface 408 may include one or more interface mechanisms for enabling communication with other devices external to the vehicle recovery system either directly or, for example, via network 412, which may, for example, be a local area network, the Internet, or the like. In this regard, the control circuitry 402 may be configured to communicate with a UAV 480 directly or via the network 412. In some cases, the communications interface 408 may be any means such as a device or circuitry embodied in either hardware, or a combination of hardware and software that is configured to receive or transmit data from/to devices in communication with the control circuitry 402. The communications interface 408 may be a wired or wireless interface and may support various communications protocols (WIFI, Bluetooth, cellular, or the like).

With regard to specific functionality, the control circuitry 402 may be configured to interface with a number of devices. According to some example embodiments, the vehicle recovery system may comprise one or more components that assist with UAV navigation and tracking of UAVs. In this regard, the vehicle recovery system may include a beacon 416, a camera 418, radar 420, or the like. According to some example embodiments, the beacon 416 may comprise a light source that emits light at a defined wavelength for detection by a UAV to assist with navigation. The control circuitry 402 may control the beacon 416 to emit light or to discontinue emitting light. Additionally, the control circuitry 402 may be configured to control the wavelength of light that the beacon 416 emits or a pulse sequence of the light that the beacon 416 emits. According to some example embodiments, the camera 418 may be an image capture device that captures images or other video information and provides the information to the control circuitry 402 for processing. The control circuitry 402 may be configured to analyze the video information and control a camera actuator to move the camera's field of view to, for example, track and continue to capture images of a UAV (e.g., UAV 480) in flight as the UAV approaches the vehicle recovery system. Similarly, the radar 420 may be configured to use radio signal returns to track objects in proximity to the vehicle recovery system, and the control circuitry 402 may use such tracking information to control operation of the vehicle recovery system. According to some example embodiments, the control circuitry 402 may control the operation of a capture actuator 438 that is configured to move a guide surface of the capture assembly into a desired alignment with an incoming UAV to assist with capturing the UAV.

As further described below, the control circuitry 402 may also receive presence information from vehicle presence sensors 426 of the parking assembly and determine, based on the presence information, which containment devices of the parking assembly are occupied and which containment devices are unoccupied (and available to receive a UAV). According to some example embodiments, a vehicle presence sensor 426 may be a pressure plate or a switch that is actuated by the UAV when the UAV is received into a containment device of the parking assembly. Additionally, as further described below, the control circuitry 402 may control distribution actuators 422 (e.g., motors, servos, solenoids, etc.) configured to move, for example, a distribution guide surface 423 into alignment with a selected containment device (e.g., an unoccupied containment device) to deposit a captured UAV into the selected containment device. In this regard, the control circuitry 402 may be configured to associate the presence information from the vehicle presence sensors 426 to a mapping of physical locations of the containment devices to determine the locations of containment devices that are unoccupied. As such, based on the presence information, the control circuitry 402 may select an unoccupied containment device (e.g., a closest unoccupied containment device) and control the distribution actuators 422 to move (e.g., rotate, extend, or the like) the distribution guide surface 423 into alignment with the selected containment device to deposit a UAV into the selected containment device.

According to some example embodiments, the vehicle recovery system may be configured to implement a UAV queue, for example, in association with distributing the UAVs into the containment devices. According to some example embodiments, controllable stops in the form of queue actuators 428 may be used to stop or block movement of a second UAV, while a first UAV is being distributed to a selected containment device. In this manner, more than one UAV may be captured at the same time, and the vehicle recovery system, according to some example embodiments, may be capable of distributing the UAVs one at a time by operating the UAV queue as a delay mechanism while distribution of each UAV takes place.

Additionally, the control circuitry 402 may be configured to control maintenance devices that may interact with a UAV once the UAV is deposited in a containment device. In this regard, according to some example embodiments, each containment device may comprise a charging apparatus that is configured to charge an energy storage device of a UAV. The charging apparatus may be configured to perform charging via a physical connection to the UAV or wireless charging (e.g., inductive charging). To control charging of the UAV, the charging apparatus that includes a charge switch 432 and a charge sensor 430 that are operably coupled to the control circuitry 402. The charge sensor 430 may be configured to determine a state of charge of the energy storage device of the UAV, and, based on the state of charge, the control circuitry 402 may determine how much or how long to charge the UAV. The control circuitry 402 may control operation of the charge switch 432 to activate and deactivate charging (e.g., physical connection or wireless) based on the state of charge determined from the charge sensor 430 and the vehicle presence sensor 426.

In example embodiments that charge via a physical connection, the charging apparatus may also comprise a charge probe actuator 434, and a charge probe 436. As further described below, the control circuitry 402 may being configured to detect the presence of a UAV in a containment device via the vehicle presence sensor 426 and initiate a charging process. In this regard, the control circuitry 402 may operate the charge probe actuator 434 to move the charge probe 436 into position to make a physical connection with the UAV. According to some example embodiments, because the orientation of the UAV may be known, the movement of the charge probe 436 may be linear and targeted towards a connection point with the UAV. As such, once the control circuitry 402 determines that the UAV is present in the containment device, then the control circuitry 402 may operate the charge probe actuator 434 to move charge probe 436 into a connection position.

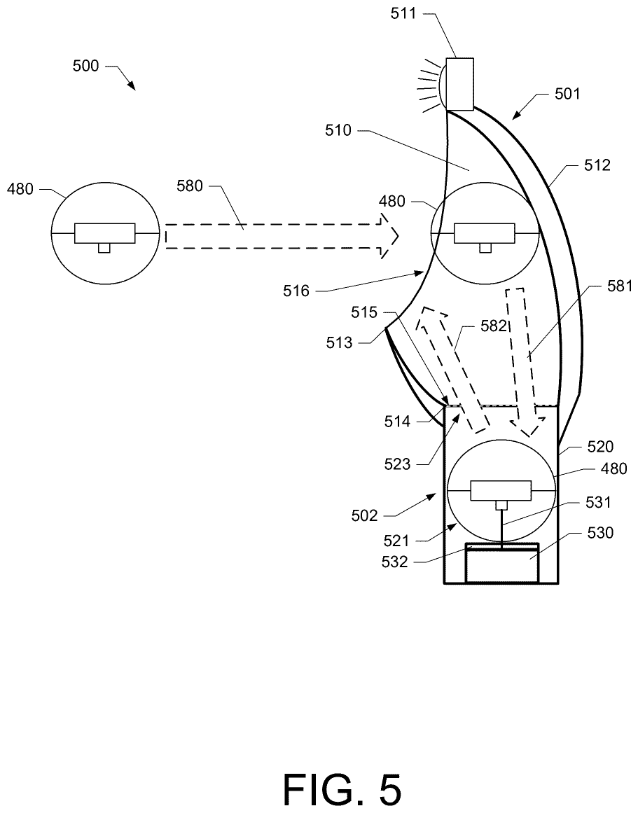

Having described example embodiments of control circuitry for a vehicle recovery system, FIG. 5 thru 14 will now be described which show example structural configurations of various example vehicle recovery systems according to some example embodiments. The various example embodiments of vehicle recovery systems include sub-structures and features that may be interchanged with other example embodiments to derive a variety of different configurations of vehicle recovery systems. As such, one of skill in art will appreciate that these are not the only configurations that fall within the scope of the embodiments disclosed herein. According to some example embodiments, the vehicle recovery systems described herein may operate with various types of UAVs having various form factors. The example embodiments shown in FIG. 5 thru 13 illustrate example embodiments that may operate in association with a UAV (e.g., UAV 480) that includes a propulsion platform operably coupled to an external cage via a three-dimensional gimbal. As such, the UAV 480, shown in FIG. 5 thru 13, may be the same or similar to the UAV 157. Although FIG. 5 thru 13 illustrate a vehicle recovery system in operation with the UAV 480, one of skill in the art would appreciate that the vehicle recovery systems shown in these figures may be modified to operate in association with other types of UAVs, such as UAVs with differently shaped external cages or UAVs with no external cage. Further, according to some example embodiments, each of the vehicle recovery systems 500, 600, 700, 800, 900, 900′, 1100, 1200, 1300, and 1400 may comprise or be operably coupled to the control circuitry 402, which may be configured to, for example, receive sensor and other information and control the operation of actuators, charging elements, and the like.

With respect to FIG. 5, a vehicle recovery system 500 is shown in cross-section. The vehicle recovery system 500 may comprise a capture assembly 501 and a parking assembly 502. The capture assembly 501 may have a narrowing shape that directs an incoming UAV 480 towards a capture passageway 515. In this regard, the capture assembly 501 may be shaped in a number of different ways. However, according to some example embodiments, the receiving opening 516 at a distal end of the capture assembly 501 may have a larger perimeter around a distal edge 513 that defines the receiving opening 516 of the capture assembly 501 than a perimeter around a proximal edge 514 that defines the capture passageway 515. In other words, according to some example embodiments, the guide surface 510 may extend from the capture passageway 515 such that a distal area defined by a perimeter of a distal edge 513 of the guide surface 510 is larger than a proximal area defined by a perimeter of a proximal edge 514 of the guide surface 510 adjacent to the capture passageway 515. The capture assembly 501 may have a number of different shapes and, in the example embodiment shown in FIG. 5, the capture assembly 501 is a clam-shell shape with an extended portion 512. Additionally, the receiving opening 516 may be directed to have a larger horizontal component of direction than a vertical component of direction to, for example, permit UAVs in horizontal flight to pass through the receiving opening 516 and contact the guide surface 510 when entering the vehicle recovery system 500.

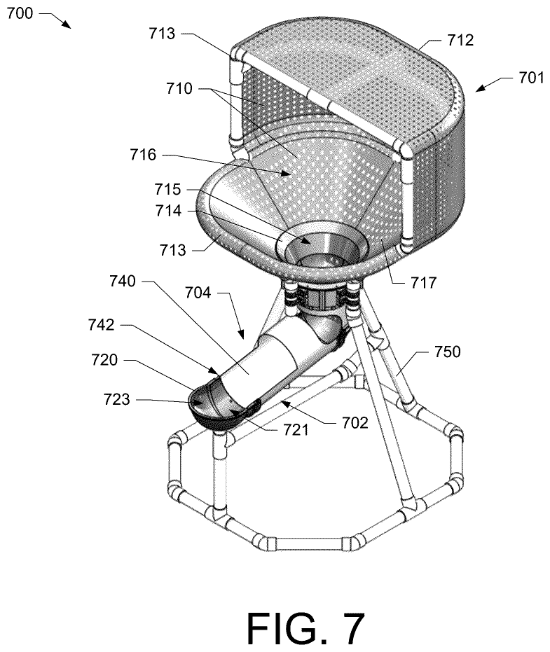

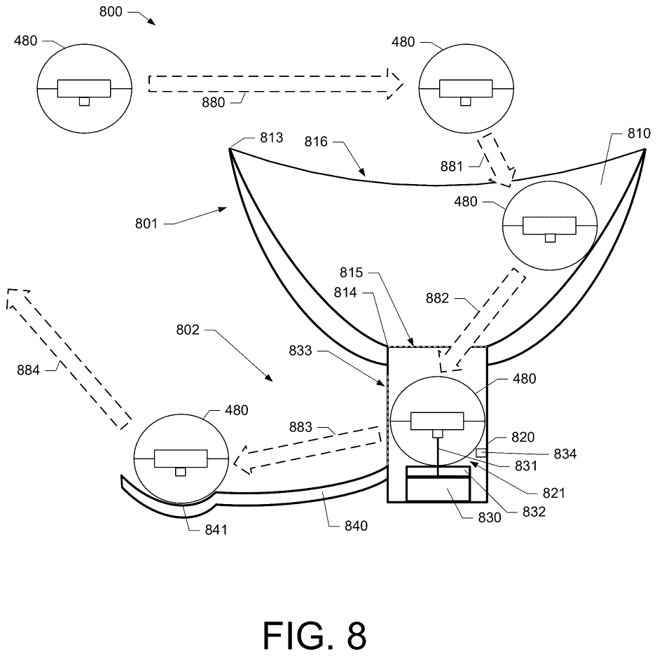

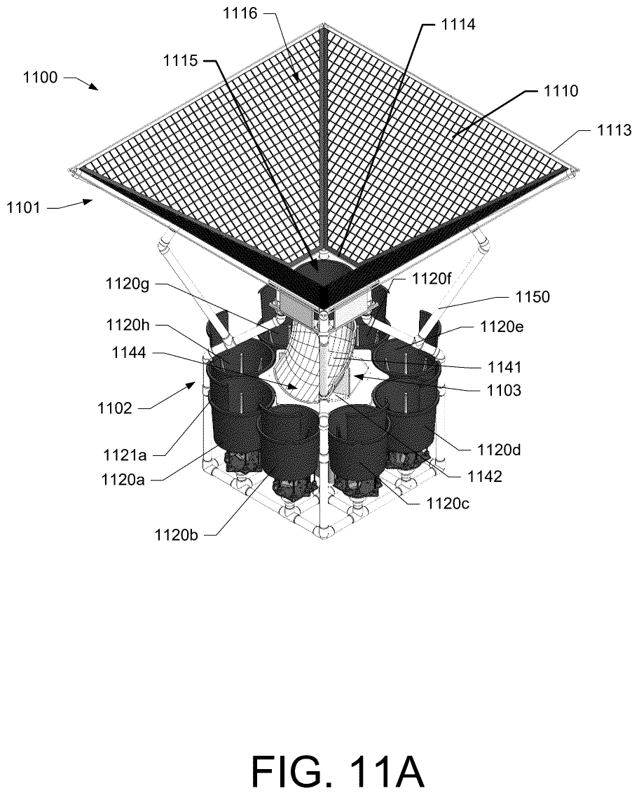

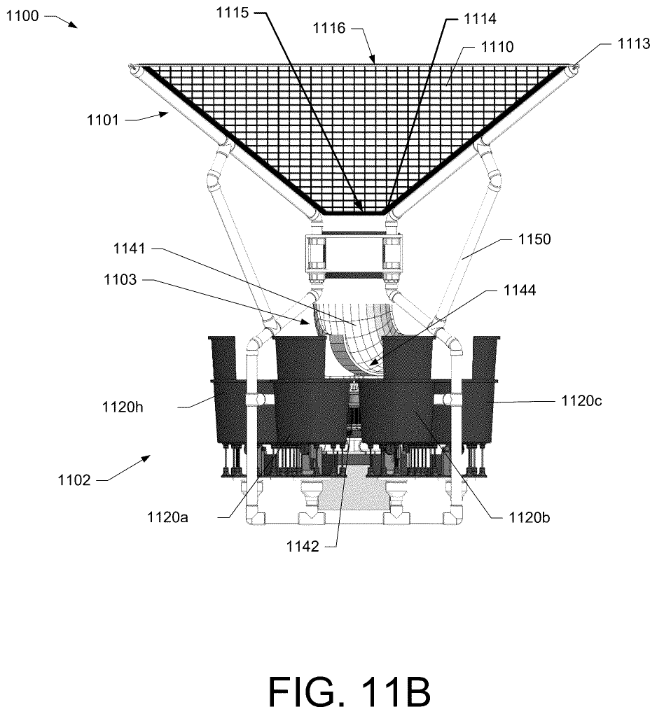

In this regard, while some example embodiments of a capture assembly as described herein may have a symmetric shape that defines a symmetric guide surface, other example embodiments of a capture assembly may have a non-symmetric shape, for example, having only partial symmetry or no symmetry. In this regard, some capture assemblies may be symmetric about an axis that is perpendicular to and passes through a center of the capture passageway. Such capture assemblies may be shaped, for example, as a cone, funnel, cup, or bowl, and the shape may define an associated guide surface (see FIG. 8, 9A-9B and 10). In other example embodiments, the capture assembly may have bilateral symmetry about a plane that passes through the center of the capture passageway, and such capture assemblies may have a guide surface shaped as an internal surface of a four-sided rectangular or square pyramid (see FIGS. 11A and 11B), a partial egg-shape, or the like. In other example embodiments, portions of the capture assembly may be planar such as a top and bottom of an interior surface of a half-cylinder shape. Further, the capture assembly may be formed of two or more discontinuous shapes such as, for example, a funnel with a rounded rectangular opening coupled to a half rounded rectangular cube shape having no bottom surface and affixed to the upper edge of the funnel, as shown in FIG. 7. As such, according to some example embodiments, the capture assembly may be formed into any shape where the perimeter of the receiving opening is larger than the perimeter of the capture passageway and the associated guide surface formed by the capture assembly directs a UAV (e.g., UAV 480), by being angled or contoured, from the receiving opening to the capture passageway.

Additionally, according to some example embodiments, the capture assembly and the guide surface may be formed by a continuous common surface, e.g., a continuous molded plastic surface. Alternatively, the capture assembly and guide surface may be structured as a support frame with unstructured material, such as, for example, fabric, netting, flexible plastic, or the like held by the support frame. According to some example embodiments, the guide surface may be formed by a net that, for example, is formed of nylon or the like. According to some example embodiments, the guide surface may be flexible to absorb an impact of a UAV that flies into the guide surface. In this regard, according to some example embodiments, the guide surface may include a lip or lesser extended portion around the capture passageway to catch a UAV that may ricochet off of a more extended portion of the capture assembly. According to some example embodiments, the guide surface may include small openings (i.e., openings smaller than a UAV) to reduce wind resistance through capture assembly, particularly in example embodiments of a vehicle recovery system that are located on a moving platform, such as a ship or other aquatic vehicle, an airplane or other aerial vehicle, or a land vehicle such as a HMMWV (high mobility multipurpose wheeled vehicle), or the like.

Also, the receiving opening of the capture assembly may be oriented in different directions according to some example embodiments. The directivity of the receiving opening may be defined by a line passing through a center of the receiving opening and being generally perpendicular to the receiving opening. According to some example embodiments, the receiving opening may be directed, for example, horizontally such that UAVs may pass through the receiving opening while travelling in a horizontal direction. Alternatively, according to some example embodiments, the receiving opening may be directed, for example, vertically such that UAVs may pass through the receiving opening while travelling downward in a vertical direction. According to some example embodiments, a capture assembly may be oriented such that a direction of the receiving opening is somewhere between horizontal and vertical.

Referring back to the vehicle recovery system 500 of FIG. 5, the capture assembly 501 may also include UAV navigation assistance features. For example, the guide surface 510 of the capture assembly 501 may have a distinctive color (e.g., a fluorescent color) that is readily identified by optical components (e.g., a camera similar to camera 145) of the UAV 480. According to some example embodiments, the guide surface 510 may include lighting elements (e.g., light emitting diodes (LEDs)) distributed across the guide surface 510. Additionally or alternatively, the capture assembly 501 may include a beacon 511. The beacon 511 may comprise an emitter that may be configured to emit an electromagnetic signal having, for example, a visible frequency, an infrared frequency, a radio frequency, or the like. In this regard, the UAV 480 may include one or more sensors configured to detect the frequency of the beacon 511 and assist navigation of the UAV 480 based on the detected beacon 511.

The parking assembly 502, according to some example embodiments, may be coupled to the proximal edge 514 of the capture assembly 501. In this regard, the parking assembly 502 may comprise a containment device 520, which may include a complementary opening to the capture passageway 515 through which the UAV 480 may pass to be positioned within a vehicle receiving space 521 of the containment device 520. According to some example embodiments, the containment device 520 may have an interior surface that may be shaped based on a shape of a UAV to receive the UAV, for example, in a desired orientation. However, because the UAV 480 includes a three-dimensional gimbal coupled between the propulsion platform and the external cage, the UAV 480 may self-orient such that, for example, a connector location for charging an energy storage device of the UAV 480 is consistently positioned in a known relative location. Thus, according to some example embodiments, the containment device 520 may have a circular internal surface shape similar to an open cylinder (e.g., cannister) having a diameter that is slightly larger than a diameter of the spherical external cage of the UAV 480 to permit the UAV 480 to be disposed in the vehicle receiving space 521 of the containment device 520.

The containment device 520 may also comprise a vehicle presence sensor 532 and a charging apparatus 530. The charging apparatus 530 and the vehicle presence sensor 532 may be positioned relative to the containment device 520 to interact with the UAV 480 while the UAV 480 is received into the vehicle receptacle space 521 of the containment device 520. The vehicle presence sensor 532 may be a pressure switch or the like that is actuated when a UAV comes into contact with pressure switch or the like. According to some example embodiments, the vehicle presence sensor 532 may be a pressure plate that detects a weight of the UAV 480 applied onto the pressure plate when the UAV 480 is within the vehicle receiving space 521 of the containment device 520. As mentioned above, the vehicle presence sensor 532 may be operably coupled to control circuitry 402 to permit the control circuitry 402 to detect the presence or absence of a UAV within the vehicle receiving space 521 of the containment device 520.

The containment device 520 may also comprise a charging apparatus 530. According to some example embodiments, the charging apparatus 530 may be a wireless charging device that uses, for example, inductive charging to charge an energy storage device of the UAV 480 by operating a charge switch of the charging apparatus 530 to activate the wireless charging. In this regard, the charging apparatus 530 may also include wireless communications hardware that may be controlled by the control circuitry 402 to make a wireless communications connection with the UAV 480 to determine a state of charge of the energy storage device from a sensor of the UAV 480. Based on the state of charge, the control circuitry 402 may determine when charging of the energy storage device is complete, and the control circuitry 402 may operate the charge switch to discontinue wireless charging.

Alternatively, the charging apparatus 530 may comprise a moveable charge probe 531. According to some example embodiments, when the control circuitry 402 detects the presence of the UAV 480 in the vehicle receiving space 521, the control circuitry 402 may be configured to control movement of the charge probe 531 to extend towards and into physical contact with a connector of the UAV 480. Subsequently, the control circuitry 402 may detect a state of charge from a charge sensor of the charging apparatus 530 and begin charging the energy storage device, by controlling a charge switch of the charging apparatus 530 based on the state of charge from the charge sensor. Upon completion of charging based on the state of charge from the charge sensor, the control circuitry 402 may operate the charging switch to discontinue charging of the energy storage device and retract the charge probe 531.

Having described the various components of the vehicle recovery system 500, the following provides a description of the operation of the vehicle recovery system 500 with respect to the movement of the UAV 480. In this regard, the UAV 480 may initially be in flight towards the capture assembly 501 of the vehicle recovery system 500. According to some example embodiments, a camera of the UAV 480 may detect, for example, the beacon 511 or a color of the guide surface 510 of the capture assembly 501, and the UAV 480 may navigate towards the guide surface 510 in response to detecting the beacon 511 or the guide surface 510. According to some example embodiments, the UAV 480 may be configured to locate the vehicle recovery system 500 via a position sensor, such as, a GPS sensor.

Due to the clam-shell shape of the capture assembly 501 with the extended portion 512, the UAV 480 may approach the capture assembly 501 in horizontal flight as indicated by arrow 580 and a forward directed camera (e.g., camera 145) may be used to assist with navigation into the capture assembly 501. In this regard, the UAV 480 may pass through the receiving opening 516 and impact the guide surface 510. As a result of the angling or contouring of the guide surface 510, the UAV 480 may be directed towards the capture passageway 515. In other words, according to some example embodiments, the guide surface 510 may be angled to funnel UAV 480 towards the capture passageway 515 in response to the UAV 480 impacting the guide surface 510. According to some example embodiments, the guide surface 510 of the capture assembly 501 may include a lip or lesser extended portion opposite the extended portion 512 to redirect the UAV 480 towards the capture passageway 515 in the event that the UAV 480 ricochets off of the guide surface 510 associated with the extended portion 512. According to some example embodiments, the UAV 480 may be configured to stop the propulsion system upon passing through the receiving opening 516 or upon impacting the guide surface 510. In either event, further movement of the UAV 480 may be the result of momentum of the UAV 480 or gravity.

As indicated by arrow 581, the UAV 480 may be directed along the guide surface 510 towards the capture passageway 515 by, for example, the UAV 480′s momentum or gravity. Subsequently, the UAV 480 may pass through the capture passageway 515 and into the vehicle receiving space 521 of the containment device 520. Upon entering the vehicle receiving space 521, the UAV 480 may come into contact with the vehicle presence sensor 532, which may provide a signal to the control circuitry 402 indicating that the UAV 480 is present within the vehicle receiving space 521 of the containment device 520 and the containment device 520 is occupied. In response, according to some example embodiments, the control circuitry 402 may establish a wireless connection between the charging apparatus 530 and the UAV 480 to determine a state of charge. Based on the state of charge, the charging apparatus 530 may begin wireless charging of the energy storage device, and continue charging until a charging sensor indicates that charging is complete.

Alternatively, in response to determining that the UAV 480 has been received into the vehicle receiving space 521 of the containment device 520, the control circuitry 402 may control the charging apparatus 530 to extend the charge probe 531 towards the propulsion platform of the UAV 480 and into a connection with a charging connector. Via the charge probe 531, the control circuitry 402 may determine a state of charge of the energy storage device of the UAV 480. According to some example embodiments, the charging apparatus 530 may include a charge sensor operably coupled to the charge probe 531 that provides information to the control circuitry 402 regarding the state of charge of the energy storage device. Based on the state of charge, the control circuitry 402 may operate a charge switch to begin charging the energy storage device. The control circuitry 402 may discontinue charging when the state of charge of the energy storage device is greater than a threshold. In response to reaching or exceeding the threshold, the charging apparatus 530 may be configured to retract the charge probe 531. As a result, maintenance may be completed and the UAV 480 may be permitted to return to flight. In this regard, the containment device 520 may include a launch opening 523 through which the UAV 480 may launch back into flight. According to some example embodiments, as shown in the vehicle recovery system 500, the launch opening 523 and the capture passageway 515 may be the same opening. As such, the UAV 480 may launch as indicated by the arrow 582.

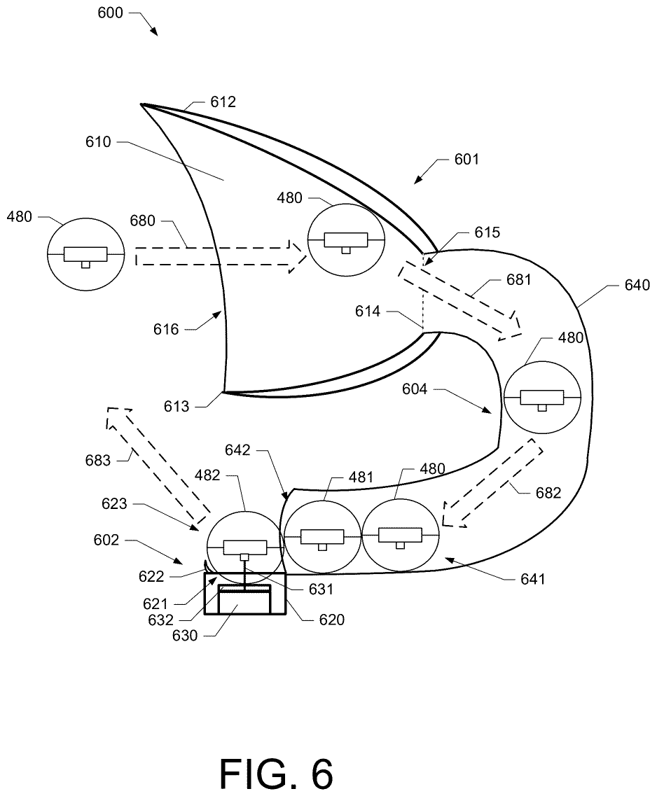

Now referring to FIG. 6, a vehicle recovery system 600 is shown, according to some example embodiments. In this regard, the vehicle recovery system 600 is shown in cross-section in FIG. 6. Similar to the vehicle recovery system 500, the vehicle recovery system 600 comprises a capture assembly 601 and a parking assembly 602. However, according to some example embodiments, the vehicle recovery system 600 may also comprise a queue assembly 604.

The capture assembly 601 may be shaped into a narrowing shape that directs an incoming UAV 480 towards a capture passageway 615. In this regard, the capture assembly 601 may be a bowl shape with an extended upper portion 612. Additionally, the receiving opening 616 may be directed with a larger horizontal component of direction than a vertical component of direction to, for example, permit UAVs in horizontal flight to pass through the receiving opening 616 and contact the guide surface 610. Again, the receiving opening 616 at a distal end of the capture assembly 601 may have a larger perimeter around a distal edge 613 that defines the receiving opening 616 of the capture assembly 601 than a perimeter around a proximal edge 614 that defines the capture passageway 615. Similar to the capture assembly 501, the capture assembly 601 may also include UAV navigation assistance features. For example, the guide surface 610 of the capture assembly 601 may have a distinctive color (e.g., a fluorescent color) that is readily identified by optical components (e.g., a camera similar to camera 145) of the UAV 480.

The parking assembly 602, according to some example embodiments, may be coupled to the proximal edge 614 of the capture assembly 601. However, unlike the parking assembly 502, the parking assembly 602 may comprise a queue assembly 604 with a queue guide surface 640 that is operably coupled to the proximal edge 614 of the capture assembly 601 and an opening into the containment device 620 of the parking assembly 602. In this regard, according to some example embodiments, the queue assembly 604 may include a queue tube or the like that includes the queue guide surface 640 as an interior surface of the queue tube or the like. The queue tube, and accordingly the queue guide surface 640, may be curved to facilitate the mostly horizontal receiving opening direction of the capture assembly 601. Additionally, a length of the queue tube and the queue guide surface 640 may be selected to permit a plurality of UAVs to be queued on the queue guide surface 640 and wait in a queue space 641 until, for example, the containment device 620 is unoccupied to allow a next UAV to enter the vehicle receiving space 621 of the containment device 620. In this regard, the queue guide surface 640 may include a varying direction shape (e.g., a C-shape, S-shape, or the like) such that the incoming UAVs reduce momentum after the UAVs pass through the capture passageway 615 due to the curved travel path of the queue guide surface 640 and contact with the inner walls.

The containment device 620 of the parking assembly 602, may be similar to the containment device 520. The queue guide surface 640 may define a queue exit opening 642 at a proximal end of the queue guide surface 640 through which a UAV may pass and subsequently move into position within the vehicle receiving space 621 of the containment device 620. Additionally, because, for example, the UAV 480 may pass through the queue exit opening 642 with some momentum, the containment device 620 may include a containment lip 622 which may extend from the containment device 620, opposite the guide exit opening 642 to block the UAV 480 from moving passed the vehicle receiving space 621 and direct the UAV 480 back into the vehicle receiving space 621.

The containment device 620 may also comprise a vehicle presence sensor 632 and a charging apparatus 630. The vehicle presence sensor 632 may be structured and operate in the same or similar manner as the vehicle presence sensor 532. The charging apparatus 630 may be structured and function in the same or similar manner as the charging apparatus 530. In this regard, the charging apparatus 630 may control the movable charge probe 631 in the same or similar manner as the charging apparatus 530 and the moveable charge probe 531.

Having described the various components of the vehicle recovery system 600, the following provides a description of the operation of the vehicle recovery system 600 with respect to the physical movement and functionalities associated with the UAVs 480, 481, and 482. In this regard, the UAVs 481, 482, 483, 484, 485, and 486 as used herein may be UAVs that are structured and function in the same manner as the UAV 480. The UAV 482 is disposed within the vehicle receiving space 621 of the containment device 620 and may be charged in the same manner as described above with respect to UAV 480 and containment device 520. In a similar manner, when charging of an energy storage device of the UAV 482 is complete, the UAV 482 may launch as indicated by the arrow 683. The UAV 481 may be disposed within the queue space 641 until the vehicle receiving space 621 of the containment device 620 is vacated by the UAV 482. In this regard, according to some example embodiments, the UAV 481 may rest against the UAV 482 until the UAV 482 moves out of the vehicle receiving space 621 by launching as indicated by the arrow 683, thereby permitting the UAV 481 to move (e.g., roll) through the queue exit opening 642 and into the vehicle receiving space 621.

With the UAVs 481 and 482 already interacting with the vehicle recovery system 600, UAV 480 may initially be positioned external to the vehicle recovery system 600 and conclude by being positioned within the queue space 641. In this regard, the UAV 480 may initially be in flight towards the capture assembly 601 of the vehicle recovery system 600. According to some example embodiments, a camera of the UAV 480 may detect, for example, a color of the guide surface 610 of the capture assembly 601, and the UAV 480 may navigate towards the guide surface 610 in response to detecting the guide surface 610. According to some example embodiments, the UAV 480 may be configured to locate the vehicle recovery system 600 via a position sensor, such as, a GPS sensor.

Due to the extended bowl-shape and mostly horizontal orientation of the capture assembly 601, the UAV 480 may approach the capture assembly 601 in horizontal flight as indicated by arrow 680 and a forward directed camera (e.g., camera 145) may be used to assist with navigation into the capture assembly 601. In this regard, the UAV 480 may pass through the receiving opening 616 and impact the guide surface 610. As a result of the angling or contouring of the guide surface 610, the UAV 480 may be directed towards the capture passageway 615. According to some example embodiments, the UAV 480 may be configured to stop the propulsion system upon passing through the capture passageway 615. Unlike the capture passageway 615, the capture passageway 615 is oriented horizontally. Therefore, although the UAV 480 may be directed by the angling and contouring of the guide surface 610 towards the capture passageway 615, the UAV 480 may be required to maintain forward propulsion until the UAV 480 passes through the capture passageway 615, after which the UAV 480 may discontinue propulsion and permit the UAV 480 to move along the queue guide surface 640 due to gravity.

Accordingly, the UAV 480 may continue as indicated by arrow 681 into the queue tube and along the queue guide surface 640 to the queue space 641, as indicated by arrow 682, without propulsion. Upon entering the queue space 641, the UAV 480 may move along the queue guide surface 640 into a position where the UAV 480 may rest against another UAV (e.g., UAV 481) while in queue waiting to move into the vehicle receiving space 621 for maintenance, such as charging, or the like.

Now referring to FIG. 7, another vehicle recovery system 700 is shown in a perspective view, according to some example embodiments. Similar to the vehicle recovery system 500, the vehicle recovery system 700 comprises a capture assembly 701 and a parking assembly 702. However, the capture assembly 701 is constructed with a different, multi-shape design. In this regard, the capture assembly 701 may be constructed to have the advantage of permitting capture of a UAV that is in horizontal flight, and also permit the UAV to discontinue propulsion upon contacting the guide surface and permit gravity and the angling or contouring of the guide surface to direct the UAV into the capture passageway.

More specifically, as seen in FIG. 7, the capture assembly 701 comprises a lower funnel-shaped portion 717. While the lower funnel-shaped portion 717 may take any funnel-like shape, the example embodiment of the lower funnel-shaped portion 717 comprises a circular proximal opening as the capture passageway 715, and a square-shaped with rounded corners distal opening. In this regard, the distal opening of the lower funnel-shaped portion 717 is directed upwards. As such, UAVs falling downward, due to no propulsion and gravity, through the distal opening of the lower funnel-shaped portion 717, may be guided by the guide surface 710 towards the capture passageway 715 due to the angling or contouring of the guide surface 710 on the lower funnel-shaped portion 717.

The capture assembly 701 may also include an upper portion 712 that is configured to support horizontal capture of UAVs. In this regard, the upper portion 712 may be coupled to half of the perimeter of the distal edge of the portion 717′s distal opening. The upper portion 712 may be shaped, for example, as a half-cube that is open on one horizontal side and on the bottom. As such, the upper portion 712 may stand above the lower portion 717 such that UAVs can fly horizontally into the guide surface 710 that is associated with the upper portion 712. As a result, the receiving opening 716, defined by the distal edge 713, may include both vertical and horizontal components in such a way that accommodates both horizontal and vertical entries into the capture assembly 701. According to some example embodiments, the upper portion 712 may be operably coupled to the lower portion 717 via a rail or other movement coupler that may be configured to permit the upper portion 712 to move (e.g., rotate, pivot, etc.) into different positions relative to the lower portion 717. In this regard, the upper portion 712 may be operably coupled to a motor or other actuator may be controlled by the control circuitry 402 to move the upper portion 712 into a desired position, for example, to receive an incoming UAV. According to some example embodiments, as shown in FIG. 7, the capture assembly 701 may be constructed as a support frame with fabric material or netting to form the guide surface 710. Otherwise, the capture assembly 701 may functionally operate in the same manner as the capture assembly 501 or 601, or as other described herein.

The parking assembly 702, according to some example embodiments, may be coupled to the proximal edge 714 of the capture assembly 701. However, unlike the parking assembly 502, the parking assembly 702 may comprise a queue assembly 704 with a queue guide surface 740 that is operably coupled to the proximal edge 714 of the capture passageway 715. Further, the queue assembly 704 may have a queue exit opening 742 to the containment device 720. In this regard, the queue assembly 704 may comprise a half-open tube, and the containment device 720 may be structured as a rounded end to the half-open tube. The containment device 720 may comprise a vehicle receiving space 721 for holding a UAV until maintenance or storage is complete and the UAV may launch from the vehicle receiving space 721 via the launch opening 723 (i.e., the open half of the pipe). Additionally, the capture assembly 701 and the parking assembly 702 may be supported by a support structure 750 of the vehicle recovery system 700. Although not shown, the containment device 720 may be configured to perform maintenance functionality including charging and the like.

Now referring to FIG. 8, a vehicle recovery system 800 is shown, according to some example embodiments. In this regard, the vehicle recovery system 800 is shown in cross-section. Similar to the vehicle recovery systems described above, the vehicle recovery system 800 comprises a capture assembly 801 and a parking assembly 802.

The capture assembly 801 may be shaped into a narrowing shape that directs an incoming UAV 480 towards a capture passageway 815. In this regard, the capture assembly 801 may be an upward-facing bowl shape that is symmetric about a center axis that passes through a center of the capture passageway 815 and is perpendicular to a plane of the capture passageway 815. Additionally, the receiving opening 816 may be directed such that UAVs may enter the capture assembly 801 from above and without permitting horizontal entry. Again, the receiving opening 816 at a distal end of the capture assembly 801 may have a larger perimeter around a distal edge 813 that defines the receiving opening 816 of the capture assembly 801 than a perimeter around a proximal edge 814 that defines the capture passageway 815. Similar to the other capture assemblies described herein, the capture assembly 801 may also include UAV navigation assistance features.

The parking assembly 802, according to some example embodiments, may be coupled to the proximal edge 814 of the capture assembly 801. The same or similar to the containment device 520, the containment device 820 may comprise a charging apparatus 830, a charge probe 831, and a vehicle presence sensor 832. However, unlike the parking assembly 502, the parking assembly 802 may comprise a second opening in the form of a release opening 833 and an ejection actuator 834. The parking assembly 802, according to some example embodiments, may be coupled to the proximal edge 814 of the capture assembly 801. The containment device 820 may include a complementary opening to the capture passageway 815 through which the UAV 480 may pass to be positioned within a vehicle receiving space 821 of the containment device 820. Upon completion of, for example, charging of the energy storage device of the UAV 480, the control circuitry 402 may be configured to trigger the ejection actuator 834. In response, the ejection actuator 834 may be configured to extend towards the UAV 480 and move the UAV 480 out of the vehicle receiving space 821 through the release opening 833. According to some example embodiments, the parking assembly 802 may also comprise a launch guide surface 840 that extends from the release opening 833 and a launch recess 841, the operation of which is described below.

Having described the various components of the vehicle recovery system 800, the following provides a description of the operation of the vehicle recovery system 800 with respect to the physical movement and functionalities associated with the UAV 480. In this regard, the UAV 480 may initially be in flight towards the capture assembly 801 of the vehicle recovery system 800. According to some example embodiments, a camera or cameras of the UAV 480 may detect, for example, UAV navigation assistance features of the capture assembly 801. According to some example embodiments, the UAV 480 may be configured to locate the vehicle recovery system 800 via a position sensor, such as, a GPS sensor.

Due to the upward-facing bowl shape of the capture assembly 801, the UAV 480 may approach the capture assembly 801 in horizontal flight as indicated by arrow 880, relying on detection via the cameras, but upon arriving at the capture assembly 801, the UAV 480 may change its approach trajectory to move downward through the receiving opening 816 and into the capture assembly 801 as indicated by arrow 881. The UAV 480 may pass through the receiving opening 816 and impact the guide surface 810. As a result of the angling or contouring of the guide surface 810, the UAV 480 may be directed towards the capture passageway 815. According to some example embodiments, the UAV 480 may be configured to discontinue propulsion upon passing through the receiving opening 816 or upon impacting the guide surface 810. In either event, further movement of the UAV 480 may be the result of momentum of the UAV 480 or gravity.

As indicated by arrow 882, the UAV 480 may be directed along the guide surface 810 towards the capture passageway 815 by, for example, the UAV 480′s momentum or gravity. Subsequently, the UAV 480 may pass through the capture passageway 815 and into the vehicle receiving space 821 of the containment device 820. The UAV 480 may be charged in the same manner as described above with respect to UAV 480 and containment device 520. However, when charging of an energy storage device of the UAV 480 is complete, the control circuitry 402 may be configured to, responsive to charging being complete, trigger the ejection actuator 834 to push the UAV 480 out of the vehicle receiving space 821 and through the release opening 833. As indicated by arrow 883, the UAV 480 may then travel, due to gravity, along the launch guide surface 840 to a launch recess 841, where the UAV 480 is stopped in preparation for launch. When prepared, the UAV 480 may launch into flight from the launch recess 841 as indicated by arrow 884, which is located some distance away from the containment device 820 to avoid interaction with other UAVs that might be entering the capture assembly 801 and the containment device 820.

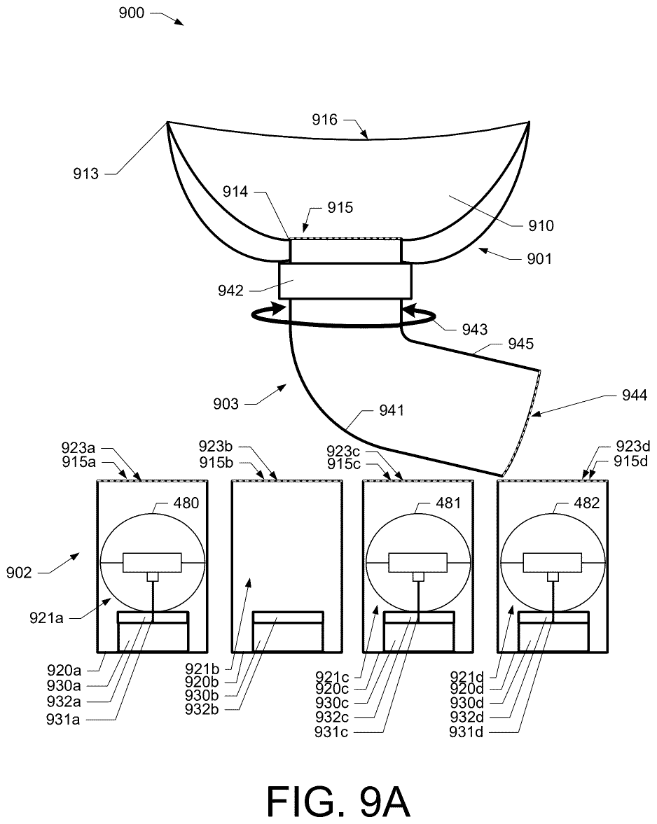

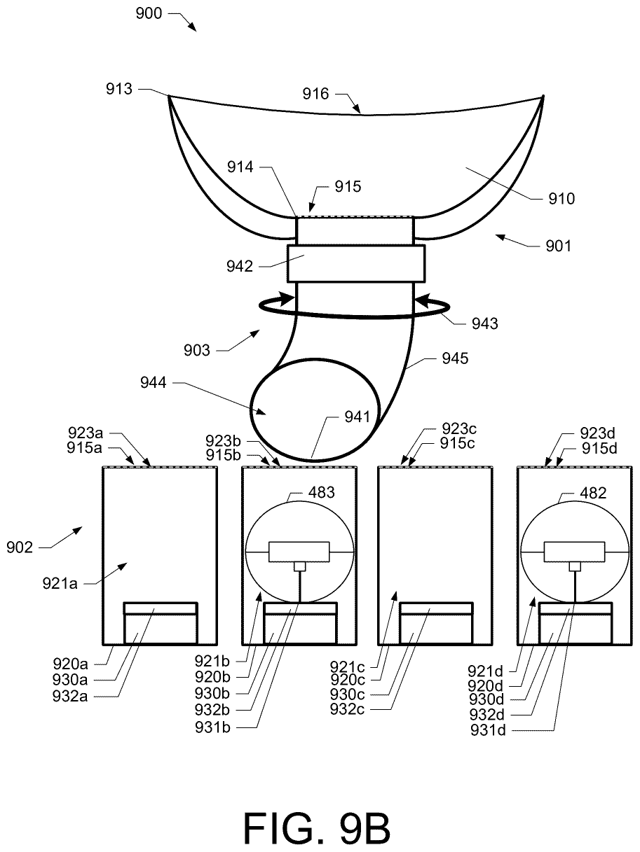

Now referring to FIGS. 9A and 9B, another vehicle recovery system 900 is shown in cross-section, according to some example embodiments. Similar to the vehicle recovery systems described above, the vehicle recovery system 900 comprises a capture assembly 901 and a parking assembly 902. However, the vehicle recovery system 900 also includes a distribution assembly 903, according to some example embodiments. The distribution assembly 903 may be configured to operate, under the control of the control circuitry 402, to distribute UAVs into a plurality of containment devices of the parking assembly 902 via movement of a distribution guide surface 941 to be aligned with a selected containment device, often because the containment device 920 is unoccupied (i.e., a UAV is not present within the vehicle receiving space of the containment device).

With regard, the structure of the vehicle recovery system 900, the capture assembly 901 may be shaped, for example, as an upward-facing bowl shape having a guide surface 910. As mentioned earlier, it is understood that any number of shapes for the capture assembly 901 may be used and the capture assembly 901 may otherwise have a structure and function the same or similar to, for example, the capture assembly 501, the capture assembly 801, or the like. That said, the capture assembly 901 may be shaped into a narrowing shape that directs an incoming UAV towards a capture passageway 915. Additionally, the receiving opening 916 may be directed such that UAVs may enter the capture assembly 901 from above and without permitting horizontal entry. Again, the receiving opening 916 at a distal end of the capture assembly 901 may have a larger perimeter around a distal edge 913 that defines the receiving opening 916 than a perimeter around a proximal edge 914 that defines the capture passageway 915. Similar to the other capture assemblies described herein, the capture assembly 901 may also include UAV navigation assistance features.

The parking assembly 902, according to some example embodiments, may comprise the distribution assembly 903. Additionally, the parking assembly 902 may comprise a plurality of containment devices. In the example embodiments of the parking assembly 902 shown in FIGS. 9A and 9B, the parking assembly 902 has four containment devices 920a, 920b, 920c, and 920d. It is understood that an example embodiment having four containment devices has been included for explanation purposes, but any number of containment devices may be included in example embodiments. The control circuitry 402 may be operably coupled to each of the containment devices 920a, 920b, 920c, and 920d to interface with or control each containment device's respective components, such as, a charging apparatus and a vehicle presence sensor.

The containment devices 920a, 920b, 920c, and 920d may each be structured and function the same or similar to the containment device 520 described above. In this regard, similar to containment device 520, the containment devices 920a, 920b, 920c, 920d may comprise entry openings 915a, 915b, 915c, 915d through which a UAV may pass to be disposed within the vehicle receiving spaces 921a, 921b, 921c, 921d, and launch openings 923a, 923b, 923c, 923d, respectively. While the entry openings and the launch openings in this example embodiment may be shared, according to some example embodiments, the entry openings and the launch openings may be disposed at different locations, such as with vehicle recovery system 800. The containment devices 920a, 920b, 920c, 920d may also comprise charging apparatuses 930a, 930b, 930c, 930d with, according to some example embodiments, charge probes 931a, 931b, 931c, 931d, and vehicle presence sensors 932a, 932b, 932c, 932d. The control circuitry 402 may be operably coupled to each of the containment devices 920a, 920b, 920c, and 920d, and the control circuitry 402 may comprise a mapping of containment devices-to-connections to determine associations between the physical placement of the containment devices and their respective vehicle presence sensors and charging apparatuses.

The distribution assembly 903 may comprise a distribution actuator 942 and a distribution guide surface 941. According to some example embodiments, the distribution guide surface 941 may be surface of a distribution tube 945 or the like. According to some example embodiments, the distribution guide surface 941 may be curved or may be a surface of an elbow component such that rotation of the elbow component permits the distribution opening 944 to move into a number of different positions that may be aligned with a respective containment device. In this regard, the distribution tube 945 may include such an elbow structure. The distribution actuator 942 may be a motor, a servo, or other controllable rotation driver that can rotate the distribution tube 945, and more specifically the distribution opening 944, into different positions under the control of the control circuitry 402.

As mentioned above, the control circuitry 402 may be operably coupled to the vehicle presence sensors of the containment devices. As such, the control circuitry 402 may be configured to poll or otherwise interface with the vehicle presence sensors to determine which containment devices are occupied and which containment devices are unoccupied. As such, if an unoccupied containment device is determined, the control circuitry 402 may be configured to control the distribution actuator 942 to rotate the distribution tube 945, as indicated by arrow 943, such that the distribution opening 944 is aligned with an unoccupied containment device. As such, when a next UAV is received into the capture assembly 901, the distribution tube 945 and the distribution opening 944 will already be positioned to cause the captured UAV to travel along the distribution guide surface 941, through the distribution opening 944, and into the unoccupied containment device. Subsequently, the containment device may operate to charge the UAV according to the various example embodiments provided herein.

Referring now to specifically FIG. 9A, UAV 480 is positioned within containment device 920a, containment device 920b is unoccupied, UAV 481 is positioned in containment device 920c, and UAV 482 is positioned in containment device 920d. The distribution tube 945 may have just distributed UAV 482 into the containment device 920d as indicated by the placement of the distribution opening 944 being aligned with the entry opening 915d. As such, charging of the UAVs 480, 481, and 482 may be performed as described herein. Additionally, since the control circuitry 402 determines that containment device 920b is the only unoccupied containment device, the control circuitry 402 may control the distribution actuator 942 to rotate the distribution guide surface 941 to be aligned with the containment device 920b and the entry opening 915b.

Referring now to FIG. 9B, the charging of UAVs 480 and 481 has completed and therefore UAVs 480 and 481 have launched back into flight via the launch openings 923a and 923c, respectively. Accordingly, containment devices 920a and 920c are left unoccupied. Additionally, another UAV 483 has been captured and has moved through the capture passageway 915, the distribution opening 944, and the entry opening 915b, and is now positioned in the vehicle receiving space 921b of the containment device 920b for charging. The UAV 482 remains charging in the containment device 920d. Accordingly, the control circuitry 402 may be configured to determine that both containment devices 920a and 920c are unoccupied based on the vehicle presence sensors 932a and 932c. As such, the control circuitry 402 may control the distribution actuator 942 to move the distribution guide surface 941 and the distribution opening 944 to one of the unoccupied containment devices. According to some example embodiments, when more than one containment device is unoccupied, the control circuitry 402 may be configured to move the distribution guide surface 941 and the distribution opening 944 to the closest containment device. In the event that two containment devices are at an equal distance away, then the control circuitry 402 may move the distribution opening 944 into alignment with the unoccupied containment device with the longest unoccupied duration.

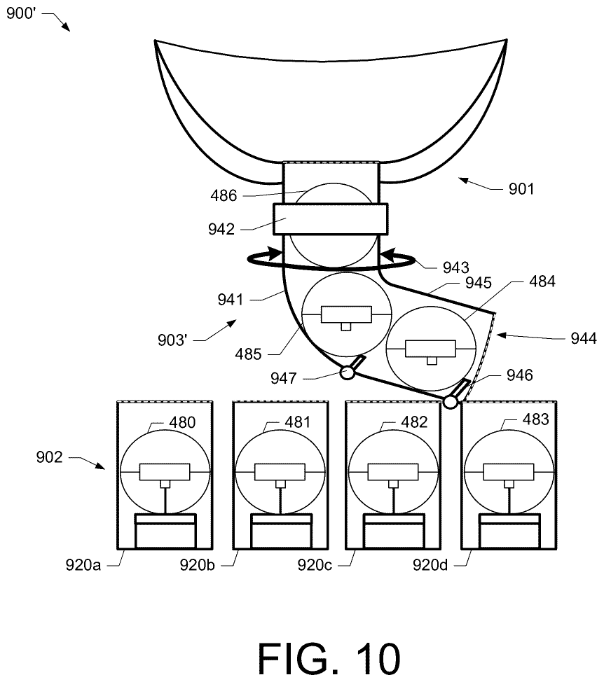

Now referring to FIG. 10, a modified embodiment of the vehicle recovery system 900 is shown in the form of vehicle recovery system 900′ with a distribution assembly 903′. In this regard, in the context of the vehicle recovery system 900′, the distribution tube 945 may also operate as a queue tube. Further, one or more controllable stops may be included on the distribution guide surface 941. In this manner, when, for example, all of the containment devices 920a, 920b, 920c, and 920d are occupied, or when the distribution opening 944 is out of position to release a UAV into an unoccupied containment device, the control circuitry 402 may control a queue actuator 946 to actuate into an extended position to operate as a stop to prevent UAVs from passing through the distribution opening 944. In this regard, the control circuitry 402 may continue to monitor the vehicle presence sensors to determine if a containment device has become unoccupied and move the distribution opening 944 to the unoccupied containment device. According to some example embodiments, the control circuitry 402 may also monitor the state of charge of the UAVs within the containment devices and determine, based on the current state of charge, which UAV is likely to reach a completed state first, and, based on this determination, the control circuitry 402 may be configured to move the distribution opening 944 to the associated containment device prior to completion of charging.

Once the distribution opening 944 is aligned with an unoccupied containment device, the queue actuator 946 may be retracted to permit the UAV 484 to move into the vehicle receiving space as described herein. As shown in FIG. 10, the UAVs 484, 485, and 486 are queued within the distribution tube 945. Accordingly, when the queue actuator 946 is retracted or opened, the UAV 484 may be permitted to move through the distribution opening 944 and into an unoccupied containment device.

In order to avoid more than one UAV from moving through the distribution opening 944 when the queue actuator 946 is retracted or opened, the distribution assembly 903′ may include a second queue actuator 947. The queue actuator 947 may be configured to stop any UAVs in a position behind the first queued UAV from moving when the queue actuator 946 is retracted or opened. Accordingly, the control circuitry 402 may, when the distribution opening 944 is aligned with an unoccupied containment device, retract the queue actuator 946 to permit the UAV 484 to be distributed into a containment device, but also maintain the queue actuator 947 in a stop position to prevent the other queued UAVs from also being released. Once the first queued UAV is released, the control circuitry 402 may control the queue actuator 946 to return to the stop or extended position, and then the queue actuator 947 may be retracted or opened to permit the next UAV (e.g., UAV 485) to move into the first queued UAV position and be stopped by the queue actuator 946. The control circuitry 402 may then return the queue actuator 947 to the stop or extended position. According to some example embodiments, operation of a queue actuator 946 may be performed in other ways, such as, with the queue actuator 946 operating as a latched device that automatically returns to the stopped or extended position in response to triggering of a mechanical switch by the movement of the first queued UAV to prevent release of more than one UAV at a time.

Now referring to FIGS. 11A and 11B, another example embodiment of a vehicle recovery system is provided as vehicle recovery system 1100. FIG. 11A illustrates the vehicle recovery system 1100 in a perspective view and FIG. 11B illustrates the vehicle recovery system 1100 in a side view. Similar to some example embodiments of the vehicle recovery systems described above, the vehicle recovery system 1100 comprises a capture assembly 1101, a parking assembly 1102, and a distribution assembly 1103.

The capture assembly 1101 may be structured with an upward-facing receiving opening 1116 defined by the distal edge 1113, and may be supported by a frame 1150. The capture assembly 1101 may comprise an inverted four-sided internal pyramid surface or a square funnel surface with the capture passageway 1115 disposed at the bottom of the capture assembly 1101 and being defined by the proximal edge 1114. The guide surface 1110 may be angled or contoured as described herein and the guide surface 1110 may be formed of a net material.

The parking assembly 1102 comprises a plurality of containment devices. In this example embodiment, the parking assembly 1102 comprises eight containment devices 1120a, 1120b, 1120c, 1120d, 1120e, 1120f, 1120g, and 1120h. These containment devices may be positioned in a circle around the centrally located distribution assembly 1103 to facilitate distribution of UAVs into the containment devices. These containment devices may also have structure and functionality the same or similar to the containment device 520. Additionally, according to some example embodiments, each containment device may comprise a respective backstop. In this regard, for example, containment device 1120a comprise a backstop 1121a. The backstop 1121a, as a representative component, may be an extension of an outer wall of the containment device 1120a relative to the centrally disposed distribution assembly 1103. Accordingly, when the distribution assembly 1103 releases a UAV to containment device 1120a, the backstop 1121a may operate to ensure that the UAV does not roll over the top of the containment device 1120a, but rather impacts the backstop 1121a and falls into the containment device 1120a. As mentioned above, each of the containment devices may include a respective backstop.

The distribution assembly 1103 may be disposed between the capture assembly 1101 and the parking assembly 1102. The distribution assembly 1103 may operate in a similar manner to the distribution assembly 903 described above. In this regard, the distribution actuator 1142 may rotate the distribution guide surface 1141, under the control of the control circuitry 402, into a desired position, e.g., in alignment with an unoccupied containment device, to permit a captured UAV to move along the distribution guide surface 1141, through the distribution opening 1144, and into the unoccupied containment device for maintenance (e.g., charging) or storage. According to some example embodiments, the distribution guide surface 1141 may be a surface of an elbow guide that extends from the capture passageway 1115 to a containment device 1120. However, rather than being coupled in a position adjacent to the capture passageway 1115, the distribution actuator 1142 may be positioned below the distribution guide surface 1141 and may be controlled to rotate the distribution guide surface 1141. In this regard, the distribution actuator 1142 may comprise a turntable to which the distribution guide surface 1141 may be affixed.

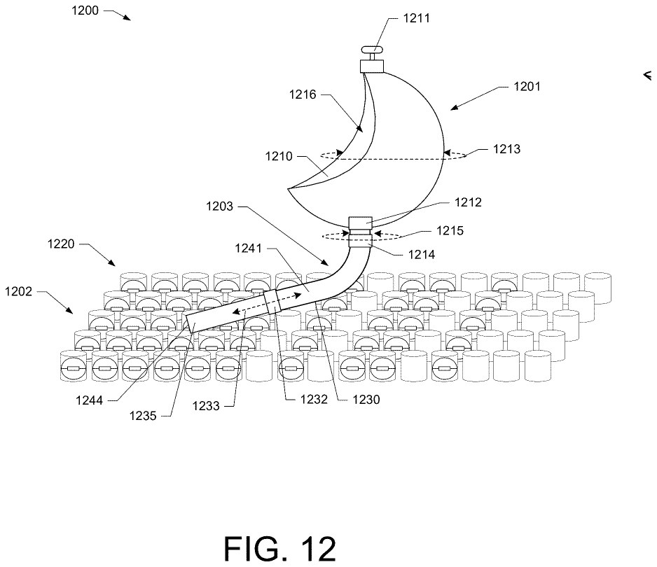

Referring now to FIG. 12, a vehicle recovery system 1200 is shown with a parking assembly 1202 having a plurality of containment devices 1220, i.e., 80 containment devices. The capture assembly 1201 may be shaped as a partial sphere with a rounded opening for the receiving opening 1216, with the internal surface of the capture assembly 1201 being the guide surface 1210. In this example embodiment, the capture assembly 1201 may comprise a capture actuator 1212 that, under the control of the control circuitry 402, causes the capture assembly 1201 to rotate relative to the plurality of containment devices as indicated by the arrow 1213. In this regard, the control circuitry 402 may interface with the radar 1211 of the capture assembly 1201 to identify the position and speed of incoming UAVs in order to turn the receiving opening 1216 towards the incoming UAV.

Additionally, the distribution assembly 1203 may comprise an elbow 1230 that comprises the distribution guide surface 1241. Additionally, the elbow 1230 may be controlled by the control circuitry 402 to rotate into a desired position for the distribution opening 1244 located at a distal end 1235 of the distribution guide surface 1241. The control circuitry 402 may rotate the elbow 1230 as indicated by arrow 1215 via control of the distribution actuator 1214. Additionally, the control circuitry 402 may extend or retract a length of the distribution guide surface 1241 (e.g., in a telescoping fashion), as indicated by arrow 1233, via the control of the extension actuator 1232. Via control of the distribution actuator 1214 and the extension actuator 1232, the control circuitry 402 may be able to align the distribution opening 1244 with any one of the plurality of containment devices. In this regard, while the plurality of containment devices are positioned in a rectangular layout, it is understood that any layout for the containment devices may be used such as a circular layout with, for example, concentric rings. Additionally, as shown in FIG. 12, many of the containment devices are unoccupied, and the control circuitry 402 may be configured to track and monitor the unoccupied containment devices to determine where to place the next captured UAV.

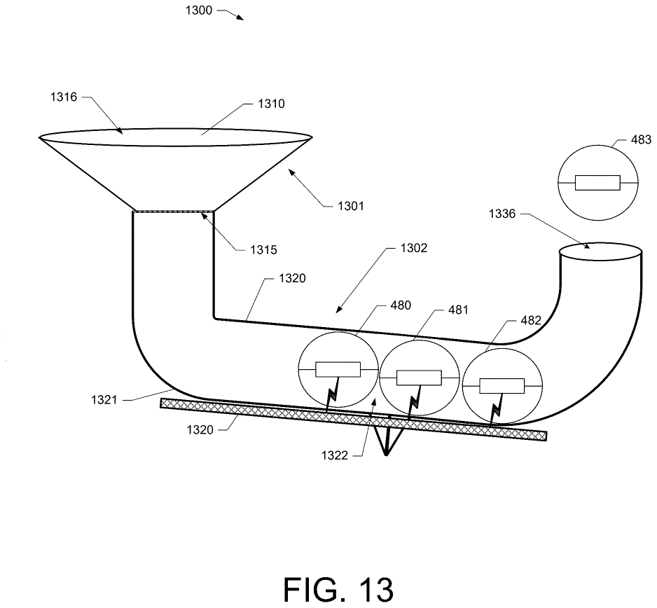

FIG. 13 illustrates another example embodiment of a vehicle recovery system in the form of a vehicle recovery system 1300. The vehicle recovery system 1300 may comprise a capture assembly 1301 having an upward-facing receiving opening 1316 and a funnel-shaped guide surface 1310 that is angled or contoured towards the capture passageway 1315. The vehicle recovery system 1300 may also comprise a parking assembly 1302 that, in turn, comprises a queue tube 1320 with a queue guide surface 1321. In this regard, the queue tube 1320 may have a U-shape with one end being coupled to the capture assembly 1301 and the other end having a launch opening 1336. Additionally, a middle portion 1322 of the queue tube 1320 may be angled in a decline to permit the UAVs to move (e.g., roll) towards a position below the launch opening 1336. Additionally, a length of the middle portion 1322 may be large enough to have a plurality of UAVs in a queue within the middle portion 1322.

Additionally, according to some example embodiments, an inductive charging plate 1320 may be disposed on a lower side of the middle portion 1322. In this regard, the inductive charging plate 1320 may wirelessly couple to a charging coil of the UAVs to charge an energy storage device of the UAVs. Accordingly, to example embodiments, an induction charging solution may be constructed in a number of other ways (i.e., different from the inductive charging plate 1320. For example, according to some example embodiments, a charging coil may be wrapped around the queue tube 1320 or portions of the queue tube 1320 to implement an inductive charging solution. As shown in FIG. 13, the UAVs 480, 481, and 482 are positioned within the middle portion 1322 adjacent to the inductive charging plate 1320 and are being charged. According to some example embodiments, the UAV in the position closest to the launch opening 1336 may remain in this position until charging of the UAV in this position (i.e., UAV 482) is complete and the UAV may then launch into flight by passing through the launch opening 1336 (e.g., UAV 483). The UAVs following the position closest to the launch opening 1336 may also be charging and may launch when charging is complete and the UAVs have moved into the position closest to the launch opening 1336.

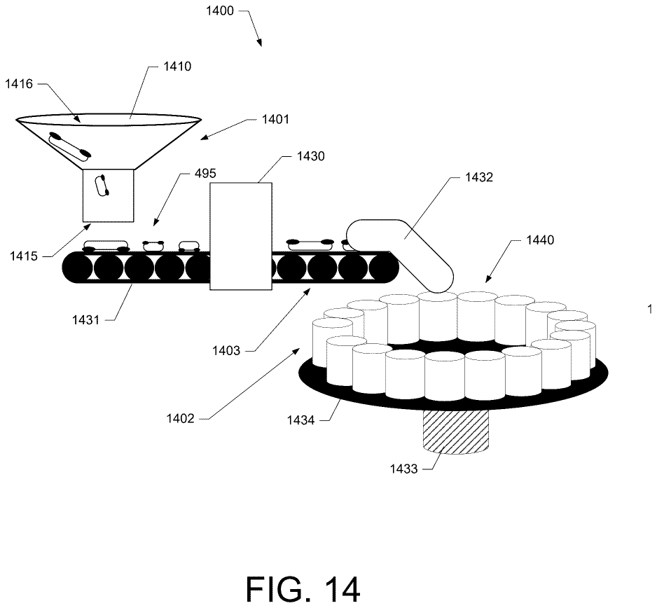

According to some example embodiments, a vehicle recovery system 1400 is shown in FIG. 14. In this regard, the vehicle recovery system 1400 may be configured for operation with a plurality of UAVs 495, where each UAV does not include an external cage and gimbal configuration, such as, for example, the UAV 100. The vehicle recovery system 1400 may comprise a capture assembly 1401 having an upward-facing receiving opening 1416 and a funnel-shaped guide surface 1410 that is angled or contoured towards the capture passageway 1415. The capture passageway 1415 may be aligned with, for example, a conveyor 1431. The UAVs 495 may be positioned in an unpredictable orientation on the conveyor 1431, the vehicle recovery system 1400 may include an orientation apparatus 1430 that is configured to receive each of the UAVs 495 in an unknown orientation and, via mechanical re-orientation members, orient the UAVs 495 into a known orientation at the output of the orientation apparatus 1430. The conveyor 1431 may move the oriented UAVs 495 into a distribution assembly 1403.

The distribution assembly 1403 may comprise a slide 1432 from the conveyor 1431 to one of a plurality of containment devices 1440 of a parking assembly 1402. Each of the containment devices 1440 may be structured and function the same or similar to the containment device 520. The plurality of containment devices 1440 may be positioned on a circular turn table 1434, and rotation of the turn table 1434 may be driven by a distribution actuator 1433. In this regard, the control circuitry 402 may be configured to determine which of the containment devices are unoccupied based on vehicle presence sensors of the containment devices and, based on a mapping of the containment devices, the control circuitry 402 may control the position of the turn table to align an unoccupied containment device with the slide 1432. The slide 1432 and the containment devices may include rails, walls, grooves, guides, or the like, to maintain the orientation of the UAVs as they move into the containment device to place the UAVs in a known orientation within the containment devices for maintenance, such as charging of an energy storage device of the UAVs. When charging of a UAV is complete, the UAV may launch from the containment device into flight.

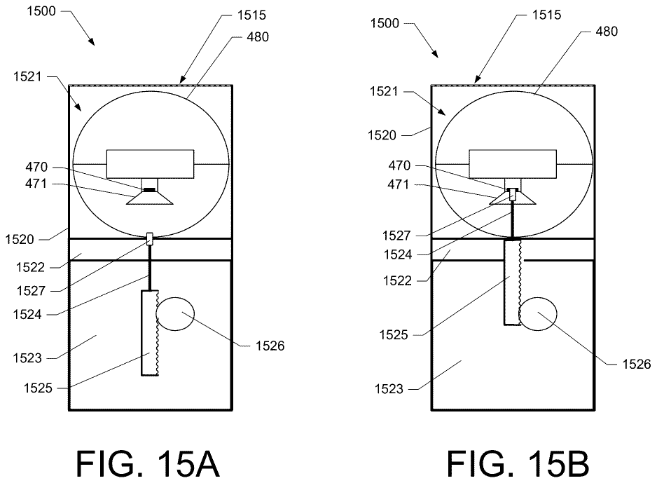

FIG. 15A to 17B will now be described which provide a more detailed description of the charging engagement for physical connection charging of the UAVs as described herein. In this regard, FIGS. 15A and 15B illustrate zoomed cross-section side views of an example containment device 1520, according to some example embodiments. The containment device 1520 may be a component of a system 1500 comprising the containment device 1520 and a UAV 480.

According to some example embodiments, a more detailed view of the UAV 480 shows that the UAV 480 may include a charge input connector 470 that may be configured to couple to a charge output connector for charging an energy storage device of the UAV 480. According to some example embodiments, a charge probe 1524 may be used to charge the UAV 480. To assist with positioning of the charge probe 1524 and to ensure connection with the charge input connector 470, the UAV 480 may also include a probe guide 471. The probe guide 471 may be, for example, a funnel or cone-shaped or angled to provide a guide surface that changes an entry direction of the charge probe 1524 towards the charge input connector 470 when the charge probe 1524 is not perfectly aligned.

The containment device 1520 may comprise an entry opening 1515 and a vehicle receiving space 1521. A UAV may enter the containment device 1520 through the entry opening 1515 to be received within the vehicle receiving space 1521 for maintenance, storage, or the like. Additionally, the containment device 1520 may comprise, similar to the containment device 520, a vehicle presence sensor 1522 and a charging apparatus 1523. The vehicle presence sensor 1522 may, according to some example embodiments, be a pressure plate or the like. The charging apparatus 1523 may be the same or similar to the charging apparatus 530. The charging apparatus 1523 may be controlled by the control circuitry 402. The charging apparatus 1523 may further include charge probe actuator 1526, a probe drive member 1525, a charge probe 1524, and a charge output connector 1527.

The charge probe actuator 1526 may be controlled by the control circuitry 402 to rotate clockwise or counterclockwise. The charge probe actuator 1526 may include a cog with, for example, teeth that may engage with teeth of the probe drive member 1525. In this regard, rotation of the cog may cause the probe drive member 1525 to extend towards the charge input connector 470 of the UAV 480 or retract away from the charge input connector 470 of the UAV 480. Accordingly, the control circuitry 402 may be configured to detect the presence of a UAV in the vehicle receiving space 1521 of the containment device 1520 from the vehicle presence sensor 1522. In response to detecting the presence of a UAV, the control circuitry 402 may control the charging apparatus 1523 and the charge probe actuator 1526 to extend the charge probe 1524 toward the UAV (e.g., UAV 480). According to some example embodiments, the charge probe 1524 may pass through an opening in the external cage of the UAV and into connection with the charge input connector 470, after possibly being redirected by the probe guide 471 as shown in FIG. 15B.

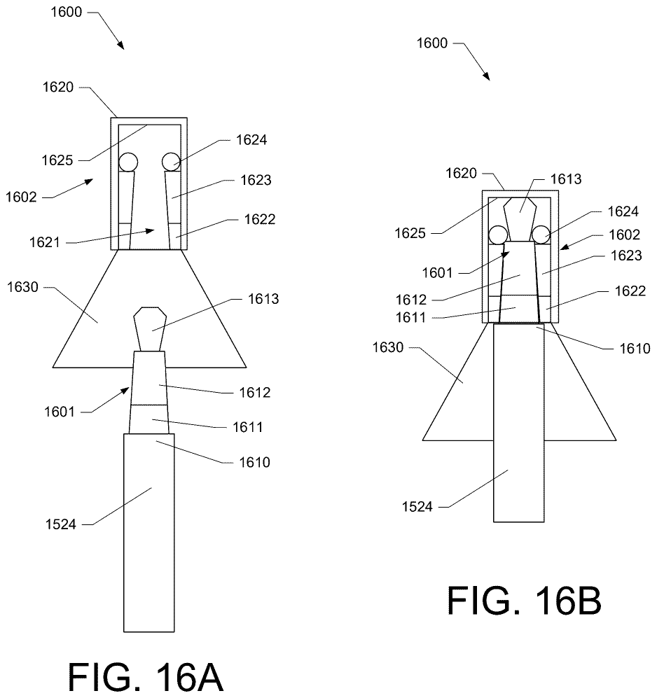

FIGS. 16A and 16B will now be described which illustrates a cross-section view of a charge connection interface 1600 comprising a charge output connector that has radial symmetry about a connector axis. In this regard, the charge output connector may be embodied as a symmetrical plug 1601 disposed at a tip 1610 of the charge probe 1524 and a charge input connector as a receptacle 1602 configured to receive and secure a connection with the plug 1601. In this regard, the plug 1601 may comprise three connection surfaces, i.e., a first output connector 1613, a second output connector 1612, and a third output connector 1611. According to some embodiments, the first output connector 1613 may be connected to positive terminal, the second output connector 1612 may be connected to a negative terminal, and the third output connector 1611 may be connected to a common ground or a data channel. Via these connectors, charging and wired communications may be performed between the UAV and the control circuitry 402.

The receptacle 1602 may comprise a body 1620 with an internal channel 1621. The internal channel 1621 may be surrounded by connectors disposed around the interior channel 1621. In this regard, the receptacle may comprise a first contact surface 1625 configured to contact the first output connector 1613, a second contact surface 1623 configured to contact the second output connector 1612, and a third contact surface 1622 configured to contact the third output connector 1611. The flexible ring 1624 may be configured to interface with an annular dimple of the plug 1601 to hold the plug 1601 in connection with the receptacle 1602.

Additionally, a probe guide 1630 may extend from an opening of the internal channel 1621 in the receptacle 1602. The probe guide 1630 may extend in a cone shape and may assist the plug 1601 align with internal channel 1621 of the receptacle 1602. In this regard, if the charge probe 1524 is off center from connecting the plug 1601 with the receptacle 1602, the plug 1601 may come into contact with the probe guide 1630, which, due to its angled sides, may cause the charge probe 1524 to be redirected into the internal channel 1621.

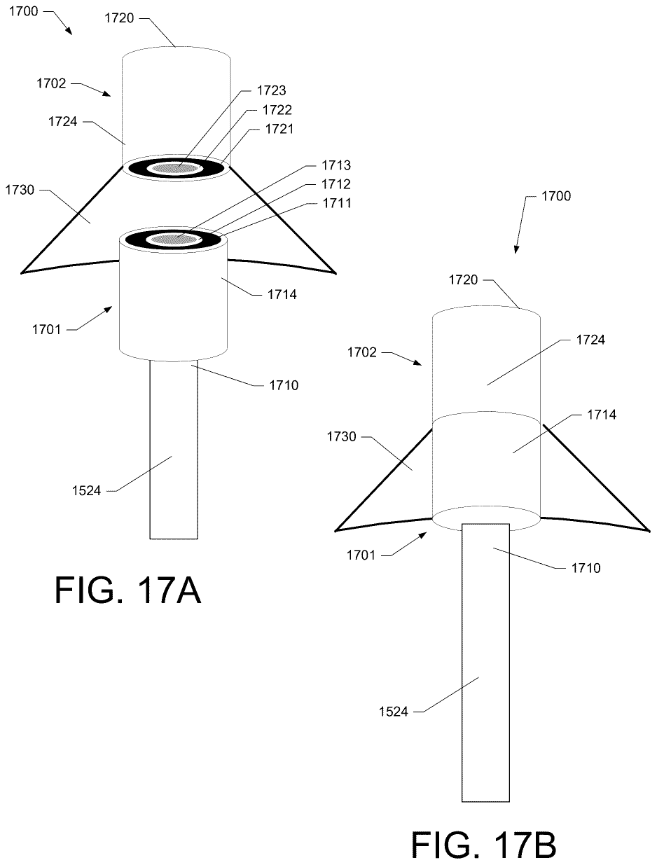

FIGS. 16A and 16B illustrated a male-female plug interface for making a charging connection between a charging apparatus and a UAV. As a different example embodiment, the FIGS. 17A and 17B illustrate a magnetic physical interface 1700 for making a charging connection and the like between the UAV and the charging apparatus. In this regard, the charge input connector in the form of a magnetic connector 1701 on the tip 1710 of the charge probe 1524 may comprise a first contact surface 1713 disposed, for example, as a central circular connector. A second contact surface 1712 may have an interface surface that is a concentric ring about the first contact surface. A third contact surface 1711 may be a magnetic surface for coupling the magnetic connector 1701 to another magnetic connector. The magnetic connector 1701 may also comprise another external ring or sheath as a fourth contact surface 1714 that may be comprised of metal for making a connection with the UAV. It is noted that other orderings of the surfaces may be used according to some example embodiments.

The magnetic physical interface 1700 may also comprise a connection 1720 from the propulsion platform to which the magnetic connector 1702 is connected. A magnetic connector 1702 may comprise a first contact surface 1723 disposed, for example, as a central circular connector. A second contact surface 1722 may have an interface surface that is a concentric ring about the first contact surface. A third contact surface 1721 may be a magnetic surface for coupling the magnetic connector 1702 to another magnetic connector. The magnetic connector 1702 may also comprise another external ring or sheath as a fourth contact surface 1724 that may be comprised of metal for making a connection with the charge probe. As shown in FIG. 17B, the magnetic connectors 1701 and 1702 are magnetically attracted to each other and the connectors come into physical and electrical connection with each other in alignment due to the positioning of the magnetic elements. Again, the probe guide 1730 may also be included for centering as the charge probe 1524 moves into close proximity with the magnetic connector 1702. The probe guide 1730 may extend from the connector 1702 in a cone-shaped configuration or the like.

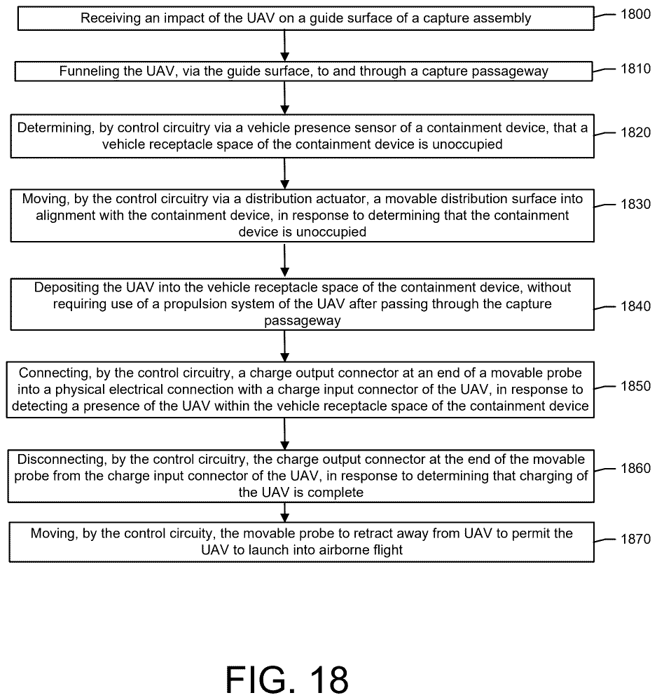

In association with the forgoing example embodiments and with reference to FIG. 18, an example method for performing maintenance on an unmanned aerial vehicle (UAV) is provided. The example method may comprise, at 1800, receiving an impact of the UAV on a guide surface of a capture assembly. Additionally, at 1810, the example method may comprise funneling the UAV, via the guide surface, to and through a capture passageway. At 1820, the example method may comprise determining, by control circuitry via a vehicle presence sensor of a containment device, that a vehicle receiving space of the containment device is unoccupied. Further, at 1830, the example method may comprise moving, by the control circuitry via a distribution actuator, a movable distribution guide surface into alignment with the containment device, in response to determining that the containment device is unoccupied. At 1840, the example method may comprise depositing the UAV into the vehicle receiving space of the containment device, without requiring use of a propulsion system of the UAV after passing through the capture passageway. Additionally, at 1850, the example method may comprise connecting, by the control circuitry, a charge output connector at an end of a movable probe into a physical electrical connection with a charge input connector of the UAV, in response to detecting a presence of the UAV within the vehicle receiving space of the containment device, and, at 1860, disconnecting, by the control circuitry, the charge output connector at the end of the movable probe from the charge input connector of the UAV, in response to determining that charging of the UAV is complete. Further, at 1870, the example method may comprise moving, by the control circuity, the movable probe to retract away from UAV to permit the UAV to launch into airborne flight.

Some additional example embodiments are further described below. The example embodiments provided below may be combined into various additional or alternative example embodiments that are within the scope of the description.

In this regard, according to some example embodiments, a vehicle recovery system is provided. The vehicle recovery system may comprise a capture assembly and a parking assembly. The capture assembly may comprise a guide surface and a capture passageway. The guide surface may extend from the capture passageway such that a distal area defined by a perimeter of a distal edge of the guide surface is larger than a proximal area defined by a perimeter of a proximal edge of the guide surface adjacent to the capture passageway. The guide surface may be angled to funnel an unmanned vehicle towards the capture passageway in response to the unmanned vehicle impacting the guide surface. The parking assembly may comprise a containment device defining a vehicle receiving space. The containment device may be positioned such that the unmanned vehicle moves into the vehicle receiving space without requiring use of a propulsion system of the unmanned vehicle after passing through the capture passageway.

Additionally, the vehicle recovery system may further comprise control circuitry. The parking assembly may further comprise a charging apparatus and a vehicle presence sensor. The charging apparatus and the vehicle presence sensor may be positioned relative to the containment device to interact with the unmanned vehicle while the unmanned vehicle is received into the vehicle receiving space of the containment device. The control circuitry may be configured to detect a presence of the unmanned vehicle within the vehicle receiving space of the containment device via the vehicle presence sensor, and, in response to detecting the presence of the unmanned vehicle within the vehicle receiving space of the containment device, execute a charging process comprising operably coupling the charging apparatus with the unmanned vehicle to charge an energy storage device of the unmanned vehicle via a physical electrical connection or a wireless electrical connection.

Additionally or alternatively, the charging apparatus may comprise a movable charge probe with a charge output connector at a charging end of the movable probe. The charging process executed by the control circuitry may comprise controlling the movable probe of the charging apparatus to move the charge output connector towards the unmanned vehicle and into the physical electrical connection with a charge input connector of the unmanned vehicle. Additionally or alternatively, the charge output connector may have radial symmetry about a connector axis. Additionally or alternatively, the charge output connector may comprise a magnet positioned to generate a magnetic connection and alignment force with the charge input connector of the unmanned vehicle. Additionally or alternatively, a data connection between the control circuitry and the unmanned vehicle may be made via the physical electrical connection between the charge output connector and the charge input connector. Additionally or alternatively, the charging apparatus may comprise a movable probe with a charge output connector at a charging end of the movable probe. A propulsion platform of the unmanned vehicle may be operably coupled to a three-dimensional gimbal that may be coupled to an external cage having a plurality of cage openings. The three-dimensional gimbal may orient the propulsion platform into a known orientation due to gravity. The propulsion platform may comprise a charge input connector, and the charging process executed by the control circuitry may comprise controlling the movable probe of the charging apparatus to move the charge output connector towards the unmanned vehicle in the known orientation, through a cage opening, and into the physical electrical connection with the charge input connector.

Additionally or alternatively, the containment device may comprise a launch opening configured to permit the unmanned vehicle to launch into airborne flight from the parking assembly. Additionally or alternatively, the unmanned vehicle may be a first unmanned vehicle. The capture assembly may comprise a vehicle queue space configured to receive and hold a second unmanned vehicle while the first unmanned vehicle is positioned within the vehicle receiving space of the containment device. Additionally or alternatively, the vehicle recovery system may further comprise a net that comprises the guide surface. Additionally or alternatively, the vehicle recovery system may further comprise control circuitry and a plurality of containment devices including the containment device. The capture assembly may further comprise a distribution assembly that is configured to receive the unmanned vehicle via the capture passageway and distribute the unmanned vehicle into one of the plurality of containment devices. The distribution assembly may comprise a movable distribution guide surface and a distribution actuator. The distribution actuator may be operably coupled to the movable distribution guide surface such that operation of the distribution actuator causes movement of the movable distribution guide surface into a plurality of distribution positions. Each distribution position may be associated with a respective containment device of the plurality of containment devices to permit one of a plurality of unmanned vehicles to be deposited into the respective containment device. The control circuitry may be configured to control operation of the distribution actuator to move the movable distribution guide surface into alignment with one of the plurality of containment devices. Additionally or alternatively, each containment device within the plurality of containment devices may comprise a vehicle presence sensor. The control circuitry may be configured to receive an indication of the presence or absence of an unmanned vehicle in each of the containment devices from each of the vehicle presence sensors, determine, from the vehicle presence sensors, the containment devices that are occupied with an unmanned vehicle and the containment devices that are unoccupied, and control operation of the distribution actuator to move the movable distribution guide surface into alignment with one of the unoccupied containment devices. Additionally or alternatively, the vehicle recovery system may further comprise a vehicle orientation machine configured to automatically orient the unmanned vehicle into a desired orientation to be deposited into the vehicle receiving space of the containment device in a known orientation.

According to some example embodiments, a system for unmanned aerial vehicle (UAV) fleet management is provided. The system may comprise a plurality of UAVs, and a vehicle recovery system. The vehicle recovery system may comprise a capture assembly comprising a guide surface and a capture passageway. The guide surface may extend from the capture passageway such that a distal area defined by a perimeter of a distal edge of the guide surface is larger than a proximal area defined by a perimeter of a proximal edge of the guide surface adjacent to the capture passageway. The guide surface may be angled to funnel a UAV towards the capture passageway in response to the UAV impacting the guide surface. The vehicle recovery system may also comprise a parking assembly comprising a plurality of containment devices. Each containment device may define a vehicle receiving space. Each containment device may be positioned such that the UAV captured by the capture assembly is moved into a vehicle receiving space of a containment device without requiring use of a propulsion system of the UAV after passing through the capture passageway.

Additionally, the vehicle recovery system further comprising control circuitry. Each of the containment devices may comprise a charging apparatus and a vehicle presence sensor. Each charging apparatus and each vehicle presence sensor may be positioned relative to a respective containment device to interact with a UAV received into the vehicle receiving space of the respective containment device. A first containment device of the plurality of containment devices may comprise a first vehicle receiving space, a first charging apparatus, and a first vehicle presence sensor. A first UAV may be received into the first vehicle receiving space of the first containment device. The control circuitry may be configured to detect a presence of the first UAV within the first vehicle receiving space via the first vehicle presence sensor; and, in response to detecting the presence of the first UAV within the first vehicle receiving space, execute a charging process comprising operably coupling the first charging apparatus with the first UAV to charge an energy storage device of the first UAV via a physical electrical connection or a wireless electrical connection.

Additionally or alternatively, the first charging apparatus may comprise a movable probe with a charge output connector at a charging end of the movable probe. The charging process executed by the control circuitry may comprise controlling the movable probe of the first charging apparatus to move the charge output connector towards the first UAV and into the physical electrical connection with a charge input connector of the first UAV. Additionally or alternatively, the charge output connector may comprise a magnet positioned to generate a magnetic connection and alignment force with the charge input connector of the first UAV. Additionally or alternatively, the vehicle recovery system may comprise control circuitry and the capture assembly may further comprise a distribution assembly. The distribution assembly may be configured to receive a UAV via the capture passageway and distribute the UAV into one of the plurality of containment devices. The distribution assembly may comprise a movable distribution guide surface and a distribution actuator. The distribution actuator may be operably coupled to the movable distribution guide surface such that operation of the distribution actuator causes movement of the movable distribution guide surface into a plurality of distribution positions. Each distribution position may be associated with a respective containment device of the plurality of containment devices to permit one of the plurality of UAVs to be deposited into the respective containment device. The control circuitry may be configured to control operation of the distribution actuator to move the movable distribution guide surface into alignment with one of the plurality of containment devices. Additionally or alternatively, each of the containment devices may comprise a charging apparatus and a vehicle presence sensor. Each charging apparatus and each vehicle presence sensor may be positioned relative to a respective containment device to interact with a UAV received into the vehicle receiving space of the respective containment device. The control circuitry may be configured to receive an indication of the presence or absence of a UAV in each of the containment devices from each of the vehicle presence sensors, determine, from the vehicle presence sensors, the containment devices that are occupied with a UAV and the containment devices that are unoccupied, and control operation of the distribution actuator to move the movable distribution guide surface into alignment with one of the unoccupied containment devices.

According to some example embodiments, a method for performing maintenance on an unmanned aerial vehicle (UAV) is provided. The method may comprise receiving an impact of the UAV on a guide surface of a capture assembly, and funneling the UAV, via the guide surface, to and through a capture passageway. The example method may further comprise determining, by control circuitry via a vehicle presence sensor of a containment device, that a vehicle receiving space of the containment device is unoccupied, and moving, by the control circuitry via a distribution actuator, a movable distribution guide surface into alignment with the containment device, in response to determining that the containment device is unoccupied. The example method may further comprise depositing the UAV into the vehicle receiving space of the containment device, without requiring use of a propulsion system of the UAV after passing through the capture passageway; and connecting, by the control circuitry, a charge output connector at an end of a movable probe into a physical electrical connection with a charge input connector of the UAV, in response to detecting a presence of the UAV within the vehicle receiving space of the containment device. The example method may further comprise disconnecting, by the control circuitry, the charge output connector at the end of the movable probe from the charge input connector of the UAV, in response to determining that charging of the UAV is complete, and moving, by the control circuity, the movable probe to retract away from UAV to permit the UAV to launch into airborne flight.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A vehicle recovery system comprising:
a capture assembly comprising a guide surface and a capture passageway, the guide surface extending from the capture passageway such that a distal area defined by a perimeter of a distal edge of the guide surface is larger than a proximal area defined by a perimeter of a proximal edge of the guide surface adjacent to the capture passageway, the guide surface being angled to funnel an unmanned vehicle towards the capture passageway in response to the unmanned vehicle impacting the guide surface; and
a parking assembly comprising a containment device defining a vehicle receiving space, wherein the containment device is positioned such that the unmanned vehicle moves into the vehicle receiving space without requiring use of a propulsion system of the unmanned vehicle after passing through the capture passageway.

2. The vehicle recovery system of claim 1 further comprising control circuitry;
wherein the parking assembly further comprises a charging apparatus and a vehicle presence sensor, wherein the charging apparatus and the vehicle presence sensor are positioned relative to the containment device to interact with the unmanned vehicle while the unmanned vehicle is received into the vehicle receiving space of the containment device;
wherein the control circuitry is configured to:
detect a presence of the unmanned vehicle within the vehicle receiving space of the containment device via the vehicle presence sensor; and
in response to detecting the presence of the unmanned vehicle within the vehicle receiving space of the containment device, execute a charging process comprising operably coupling the charging apparatus with the unmanned vehicle to charge an energy storage device of the unmanned vehicle via a physical electrical connection or a wireless electrical connection.

3. The vehicle recovery system of claim 2, wherein the charging apparatus comprises a movable charge probe with a charge output connector at a charging end of the movable charge probe;
wherein the charging process executed by the control circuitry comprises:
controlling the movable charge probe of the charging apparatus to move the charge output connector towards the unmanned vehicle and into the physical electrical connection with a charge input connector of the unmanned vehicle.

4. The vehicle recovery system of claim 3, wherein the charge output connector has radial symmetry about a connector axis.

5. The vehicle recovery system of claim 4, wherein the charge output connector comprises a magnet positioned to generate a magnetic connection and alignment force with the charge input connector of the unmanned vehicle.

6. The vehicle recovery system of claim 3, wherein a data connection between the control circuitry and the unmanned vehicle is made via the physical electrical connection between the charge output connector and the charge input connector.

7. The vehicle recovery system of claim 2, wherein the charging apparatus comprises a movable charge probe with a charge output connector at a charging end of the movable charge probe;
wherein a propulsion platform of the unmanned vehicle is operably coupled to a three-dimensional gimbal that is coupled to an external cage having a plurality of cage openings, wherein the three-dimensional gimbal orients the propulsion platform into a known orientation due to gravity, wherein the propulsion platform comprises a charge input connector;
wherein the charging process executed by the control circuitry comprises:
controlling the movable charge probe of the charging apparatus to move the charge output connector towards the unmanned vehicle in the known orientation, through a cage opening, and into the physical electrical connection with the charge input connector.

8. The vehicle recovery system of claim 1, wherein the containment device comprises a launch opening configured to permit the unmanned vehicle to launch into airborne flight from the parking assembly.

9. The vehicle recovery system of claim 1, wherein the unmanned vehicle is a first unmanned vehicle;
wherein the capture assembly comprises a vehicle queue space configured to receive and hold a second unmanned vehicle while the first unmanned vehicle is positioned within the vehicle receiving space of the containment device.

10. The vehicle recovery system of claim 1 further comprising a net, wherein the net comprises the guide surface.

11. The vehicle recovery system of claim 1, further comprising control circuitry and a plurality of containment devices including the containment device;
wherein the capture assembly further comprises a distribution assembly;
wherein the distribution assembly is configured to receive the unmanned vehicle via the capture passageway and distribute the unmanned vehicle into one of the plurality of containment devices;
wherein the distribution assembly comprises a movable distribution guide surface and a distribution actuator, the distribution actuator being operably coupled to the movable distribution guide surface such that operation of the distribution actuator causes movement of the movable distribution guide surface into a plurality of distribution positions, each distribution position being associated with a respective containment device of the plurality of containment devices to permit one of a plurality of unmanned vehicles to be deposited into the respective containment device;
wherein the control circuitry is configured to control operation of the distribution actuator to move the movable distribution guide surface into alignment with one of the plurality of containment devices.

12. The vehicle recovery system of claim 11, wherein each containment device within the plurality of containment devices comprises a vehicle presence sensor;
wherein the control circuitry is configured to:
receive an indication of the presence or absence of an unmanned vehicle in each of the containment devices from each of the vehicle presence sensors;
determine, from the vehicle presence sensors, the containment devices that are occupied with an unmanned vehicle and the containment devices that are unoccupied; and
control operation of the distribution actuator to move the movable distribution guide surface into alignment with one of the unoccupied containment devices.

13. The vehicle recovery system of claim 1 further comprising a vehicle orientation machine configured to automatically orient the unmanned vehicle into a desired orientation to be deposited into the vehicle receiving space of the containment device in a known orientation.

14. A system for unmanned aerial vehicle (UAV) fleet management, the system comprising:
a plurality of UAVs; and
a vehicle recovery system comprising:
a capture assembly comprising a guide surface and a capture passageway, the guide surface extending from the capture passageway such that a distal area defined by a perimeter of a distal edge of the guide surface is larger than a proximal area defined by a perimeter of a proximal edge of the guide surface adjacent to the capture passageway, the guide surface being angled to funnel a UAV towards the capture passageway in response to the UAV impacting the guide surface; and
a parking assembly comprising a plurality of containment devices, each containment device defining a vehicle receiving space and each containment device being positioned such that the UAV captured by the capture assembly is moved into a vehicle receiving space of a containment device without requiring use of a propulsion system of the UAV after passing through the capture passageway.

15. The system of claim 14 wherein the vehicle recovery system further comprises control circuitry;
wherein each of the containment devices comprises a charging apparatus and a vehicle presence sensor, wherein each charging apparatus and each vehicle presence sensor are positioned relative to a respective containment device to interact with a UAV received into the vehicle receiving space of the respective containment device;
wherein a first containment device of the plurality of containment devices, comprises a first vehicle receiving space, a first charging apparatus, and a first vehicle presence sensor, a first UAV being received into the first vehicle receiving space of the first containment device;
wherein the control circuitry is configured to:
detect a presence of the first UAV within the first vehicle receiving space via the first vehicle presence sensor; and
in response to detecting the presence of the first UAV within the first vehicle receiving space, execute a charging process comprising operably coupling the first charging apparatus with the first UAV to charge an energy storage device of the first UAV via a physical electrical connection or a wireless electrical connection.

16. The system of claim 15, wherein the first charging apparatus comprises a movable charge probe with a charge output connector at a charging end of the movable charge probe;
wherein the charging process executed by the control circuitry comprises:
controlling the movable charge probe of the first charging apparatus to move the charge output connector towards the first UAV and into the physical electrical connection with a charge input connector of the first UAV.

17. The system of claim 16, wherein the charge output connector comprises a magnet positioned to generate a magnetic connection and alignment force with the charge input connector of the first UAV.

18. The system of claim 14, wherein the vehicle recovery system comprises control circuitry and the capture assembly further comprises a distribution assembly;
wherein the distribution assembly is configured to receive a UAV via the capture passageway and distribute the UAV into one of the plurality of containment devices;
wherein the distribution assembly comprises a movable distribution guide surface and a distribution actuator, the distribution actuator being operably coupled to the movable distribution guide surface such that operation of the distribution actuator causes movement of the movable distribution guide surface into a plurality of distribution positions, each distribution position being associated with a respective containment device of the plurality of containment devices to permit one of the plurality of UAVs to be deposited into the respective containment device;
wherein the control circuitry is configured to control operation of the distribution actuator to move the movable distribution guide surface into alignment with one of the plurality of containment devices.

19. The system of claim 18, wherein each of the containment devices comprises a charging apparatus and a vehicle presence sensor, wherein each charging apparatus and each vehicle presence sensor are positioned relative to a respective containment device to interact with a UAV received into the vehicle receiving space of the respective containment device;
wherein the control circuitry is configured to:
receive an indication of the presence or absence of a UAV in each of the containment devices from each of the vehicle presence sensors;
determine, from the vehicle presence sensors, the containment devices that are occupied with a UAV and the containment devices that are unoccupied; and
control operation of the distribution actuator to move the movable distribution guide surface into alignment with one of the unoccupied containment devices.

20. A method for performing maintenance on an unmanned aerial vehicle (UAV), the method comprising:
receiving an impact of the UAV on a guide surface of a capture assembly;
funneling the UAV, via the guide surface, to and through a capture passageway;
determining, by control circuitry via a vehicle presence sensor of a containment device, that a vehicle receiving space of the containment device is unoccupied;
moving, by the control circuitry via a distribution actuator, a movable distribution guide surface into alignment with the containment device, in response to determining that the containment device is unoccupied;
depositing the UAV into the vehicle receiving space of the containment device, without requiring use of a propulsion system of the UAV after passing through the capture passageway;
connecting, by the control circuitry, a charge output connector at an end of a movable charge probe into a physical electrical connection with a charge input connector of the UAV, in response to detecting a presence of the UAV within the vehicle receiving space of the containment device;
disconnecting, by the control circuitry, the charge output connector at the end of the movable charge probe from the charge input connector of the UAV, in response to determining that charging of the UAV is complete; and
moving, by the control circuity, the movable charge probe to retract away from UAV to permit the UAV to launch into airborne flight.
